(19) United States
(12) Patent Application Publication
(10) Pub. No.: US 2025/0173645 A1
(43) Pub. Date: May 29, 2025

(54) PROJECT WORKFLOW MANAGEMENT SYSTEM

(71) Applicant: CENTERLINE PIM INC., New Orleans, LA (US)

(72) Inventor: Charles Emile Perret, III, New Orleans, LA (US)

(21) Appl. No.: 18/957,037

(22) Filed: Nov. 22, 2024

Related U.S. Application Data
(60) Provisional application No. 63/603,015, filed on Nov. 27, 2023.

(51) Int. Cl. G06Q 10/0631; G06Q 10/10; G06V 30/422

(52) U.S. Cl. CPC G06Q 10/063114; G06Q 10/103; G06V 30/422

(57) ABSTRACT

Systems and methods of project workflow management based on files related to the project. In some implementations, a file, such as a specification or a set of drawings, can be accessed by the project workflow management system. Based on information extracted from the file, the systems and methods can generate an index based on the extracted information. In addition, systems and methods can determine instructions relating to the project and generate tasks to be accomplished by various team members in completing the project. The systems and methods can provide an interface by which various team members can interact to accomplish steps of the project. In addition, the systems and methods can track the progress of the project, including the status of specific tasks to be executed by various parties.

### PRIORITY AND RELATED APPLICATIONS

This present application claims the benefit of U.S. Provisional Application No. 63/603,015 filed on Nov. 27, 2023, entitled PROJECT WORKFLOW MANAGEMENT SYSTEM. Any and all applications for which a foreign or domestic priority claim is identified in the Application Data Sheet as filed with the present application are hereby incorporated by reference under 37 CFR § 1.57.

### BACKGROUND

Project management involves the regulation and supervision of a project from early development through completion. Specifically, project management for a construction or building project, for example, involves numerous steps, tasks, and required documentation performed or provided by various parties. For example, a project can involve the collection of bids from contractors bidding on the project, review and approval of blueprints and other design documents, building code certification process and progress, or similar. Accordingly, there can be a complex set of requirements, documents, schedules, notifications, and the like that must be tracked and managed simultaneously. Such complexity makes it difficult for a project manager to manage projects effectively.

### BRIEF DESCRIPTION OF THE DRAWINGS

The patent or application file contains at least one drawing executed in color. Copies of this patent or patent application with color drawings will be provided by the Office upon request and payment of the necessary fee.

Various features will now be described with reference to the following drawings. Throughout the drawings, reference numbers can be re-used to indicate correspondence between referenced elements. The drawings are provided to illustrate examples described herein and are not intended to limit the scope of the disclosure.

FIG. 1 is a schematic block diagram of an example network environment in which a project workflow management system can operate, according to various aspects of the present disclosure;

FIG. 2 is a flow diagram of an exemplary process for document text extraction in a project workflow management system;

FIG. 3 is a flow diagram of an exemplary process for document feature extraction in a project workflow management system;

FIGS. 4A-4B illustrate example screenshots of the document text extraction system of the project workflow management system, according to various aspects of the present disclosure;

FIGS. 5A-5E illustrate example screenshots of the document feature extraction system of the project workflow management system, according to various aspects of the present

FIG. 6 is a block diagram illustrating components of an example computing system that can be used to implement the various systems and methods described herein.

### DETAILED DESCRIPTION

Aspects of the present disclosure relate to a system of workflow management, such as for a construction project. It is noted that a typical construction project might include a team of people, such as one or more owners, financiers, architects, designers, contractors, and/or builders. Without adequate communication between team members, many issues can arise throughout the life of a project. Such issues can result in divergences from designs and approved plans, delays, missed deadlines, or even safety risks. In some cases, costly litigation risks can arise stemming from miscommunication mishaps. Therefore, ensuring that each participant in the project is following guidelines set forth in the construction specification is important to reduce risks of error and miscommunication. In the context of project management, a workflow refers to the sequence of processes through which a project passes through from initiation to completion. For example, some steps can be performed concurrently, while others can require certain actions to be completed before being initialized. In some cases, for example, a construction project can be broken down into four stages: design, bidding, construction, and close out.

During the design stage, architects, developers, designers, and/or other parties or entities can collaborate to create design drawings and other foundational plans for a project. During the bidding stage, contractors, subcontractors, and other service providers can be secured to work on the designed project. During the construction stage, various parties (e.g., such as the one or more contractors that can have won the bid for the project) start construction to build the designed project. In addition, scheduling, due dates, and other contractual information can be handled by a project manager, including anyone acting in such a capacity. Finally, during the close out stage, various people (e.g., contractors, engineers, architects, or the like) can include any additional or outstanding task to be completed before the project is deemed finished or complete. For example, additional or outstanding tasks can include completing certifications, correcting construction defects, replacing items that are undesirable, or similar minor or administrative tasks. In this context, a workflow for a building project can comprises a number of actions or tasks spanning from design to close out, some of which can be completed in a certain order to finish a building project. Each event can include a variety of actions or tasks to be completed, such as the execution and/or approvals of certain documents, reminders to be sent to certain parties, or the completion of specific tasks. In the context of a building or construction project workflow, for example, events can include floorplan approvals, securing of contractor bids, and closeout tasks (e.g., confirming the final transfer of assets to a client).

Furthermore, a workflow can vary significantly between projects and can also be adjusted or updated during a project based on the progression of the specific project. For example, delays in the approval of a building floorplan by an owner or financier can affect the start date of physical construction by a contractor.

Construction projects typically include an accompanying construction or architectural specification, also referred to as a project manual. In the context of construction projects, an accompanying specification is a written document describing the scope of the work that is needed, recommended or required materials, methods of constructing or manufacturing, and quality of workmanship (e.g., such as an industry standard or certification level) of a project. For example, methods of construction or manufacture can include any specific instruction, guidance, rule, or process related to constructing of a project (e.g., a building, or the like).

Typically, a specification includes details relating to how a structure is to be constructed, altered, removed, demolished, etc. Although specifications can vary depending on the author and type of project, an industry-standard specification might be include multiple “divisions” and within each division there can be one or more “sections” and “subsections” corresponding to a unique identifier. As used herein, a combination of a division-section-subsection identifier can be referred to as a “specification number.”

Divisions, for example, relate to high-level industry classifications of construction work. These divisions generally categorize the type of work needed to be accomplished for a project within a specific area. For example, divisions in a typical specification can include concrete, masonry, wood, plastics and composites, thermal and moisture protection, openings, finishes, specialties, toilet and bath accessories, equipment, furniture, parking structures, electrical, food service, HVAC, plumbing, communications, earthwork, sewage, etc. Each division in the specification can include instructions relating to the construction work needed to be done. Divisions can each be numbered by a unique identifier, such as according to one or more industry standards (e.g., masonry is division 4, thermal and moisture protection is division 7, etc.), or any other ordering. As mentioned, each division can be further tiered into sections and subsections, which the sections and subsections can also be numbered according to industry standard codes. For some projects, for example, a complete division, section, and subsection specification number is identified by a 6-digit identifier (e.g., division 7 titled “thermal and moisture protection” includes a section entitled “thermal insulation” which is identified by the following specification number: 07 21 00 indicating the division, section, and subsection). Divisions and sections are typically outlined in a table of contents at the beginning of a specification document.

For some projects, the specification document can include specific instructions or requirements for various parties, such as contractors, architects, etc. to follow during a project as defined or described in various divisions and sections. In some examples, some requirements can be referred to as “submittals,” and can be further defined as “action submittals,” “informational submittals,” and the like. Action submittals are typically required prior to purchase, manufacture, or delivery of materials to be incorporated into the project. In some cases, an action submittal can include specific actions that are required to be completed, such as submission of a materials sample to the lead designer. In one example, a “valves for plumbing” section can include a request for product data pertaining to specific valves. The requested product data can include, for each type of valve required for the project, a pressure rating, a capacity, an electrical connection, or any other specific information. Information submittals can indicate information about the work to be done on the project, certifications, quality control purposes, etc. Typically, information submittals can be reviewed by design professionals or other coordinators to determine whether the contracted work and/or parties themselves are in compliance with contract documents. This can include submission of specific documentation, such as drawings, certificates, or other related documents. For example, an information submittal listed in a sewage section can include a request for welding certificates from contractors or piping schematics from a lead engineer or designer. These submittals and/or other instructions laid out in the specification can guide the overall workflow of the project. In addition, these instructions can, for some tasks, define a specific order for the task are to be completed. For example, submission of a materials lists for can need to be approved by designers before the materials can be purchased. In addition, the specification can lay out specific licenses, insurance documents, and/or certification to be on file before any substantive work can begin.

Also foundational to any construction project are the drawings. Drawings can include any floorplans, blueprints, designs, diagrams, etc. that detail design decisions for a specific building project. Drawings and other designs are typically revised and updated throughout the project. If drawings are updated, new or replacement drawings would be circulated to relevant parties as “architect supplemental instructions.” It is crucial that all relevant parties are aware of updates to the drawings and have access to the corresponding files.

Organization and management of a project workflow can be a challenge. In some implementations, a project workflow management system, as described herein, can be used to manage workflows for a construction or building project based on a custom specification and the project's accompanying drawings. The project workflow management system can be configured to display a user interface and act as a central hub for management of the entire workflow of a project between all teams (e.g., architects, engineers, . . . , etc.). For example, the project workflow management system accesses or receives relevant documents, such as the specification, drawings, floorplans, certifications, reports, etc., and is configured to extracts relevant information from the documents to then implement automatically across the teams to ensure compliance and accuracy among the team members. The project workflow management system can automate the process of workflow management by generating notifications, reminders, access keys, etc. to inform and prompt relevant team members to execute certain steps of the workflow. Automation of the workflow management, such as automatic notifications, emails, event, reminder, smart link, text message, or other notification (such as a push notification) processed between team members, for example, can be based on information of uploaded documents, such as the procedures of the specification.

The project workflow management system can also include various tools, or integrated applications. These tools, for example, can be available for project managers, architects, designers, contractors, owners, etc. to access. For example, one tool the project workflow management system can include is a workflow generation system. In some implementations, the workflow generation system can be configured to access an electronic document, such as a specification document corresponding to a specific project, and generate a workflow for the project based on identified features of the specification document (e.g., table of contents, divisions, sections, headings, titles, and other extracted information). The features can then be used to generate procedures or tasks that are then programmed into a workflow for the specific project corresponding to the document. In addition, based on the procedures, the project workflow management system can be configured to track progress of the procedures, generate notifications, reminders, access keys, and the like to inform and prompt relevant team members that they are responsible for a certain action item of the workflow (e.g., based on the information in the specification) and to receive, process, and update other team members as procedures are completed and/or procedures or responsibilities are updated to be assigned to different team members. Notifications can be sent to relevant team members via email, and can even include custom programmed links, such as “smart links,” for access to certain documents and/or areas of the project workflow management system interface.

In addition, the project workflow management system can be configured to access an electronic document (e.g., a floorplan, blueprint, or other design file), and receive user input indicating a marked-up feature in the document. For example, a marked-up feature can relate to a drawing number, an object on a floorplan or blueprint, a drawing title, or similar. In addition, the document feature extraction system can generate a workflow for the project based on the identified features, such as creating work events relating to documentation that is needed for a specific feature identified in the blueprint.

The project workflow management system can also include other tools accessible by users and useful to the overall project workflow. For example, owners or managers might desire to track the progress of an open procedure. It would be helpful, therefore, for a system such as the project workflow management system to keep a record of events required by the specification document, submissions by one or more parties, or other procedures being performed. In addition, the project can involve parties who are not considered central to the project but are still relevant for certain events within the workflow. To provide access, the project workflow management system can include a link tracking system (e.g., “smart links”) by which custom programmed links can be sent to various parties to access portions of the project workflow management system. In some implementations, the custom programmed links can be sent to a person prompting the person to upload or execute specific documents, such as certification forms etc. In some implementations, smart links can allow recipients to access portions of the project workflow management system without creation of an account with the project workflow management system. This feature can streamline contributions by various parties who do not otherwise need to register with the project workflow management system apart from uploading or providing one-time submissions.

The project workflow management system can also provide capabilities to integrate with third parties through virtual servers or integrate with third party applications. This can extend the range of services provided by the project workflow management system and accessible by users. For example, third party applications or services can include bidding portals through which owners can list and accept bids from contractors (and related parties). Additional applications can include construction management software, budgeting programs, and the like.

In addition, the project workflow management system can also provide any relevant collaboration-focused application, program, software, etc. that can be used by team members for completing a procedure or project. In one example, a collaboration tool can be configured to allow team members to organize and collaborate on documents, such as PDF files of drawings, blueprints, etc. via a virtual server. In some examples, the collaboration can be utilized to allow multiple users and/or system to access a single license (e.g., account) for collaboration programs.

### I. Project Workflow Management System Within Network and/or Operating Environment

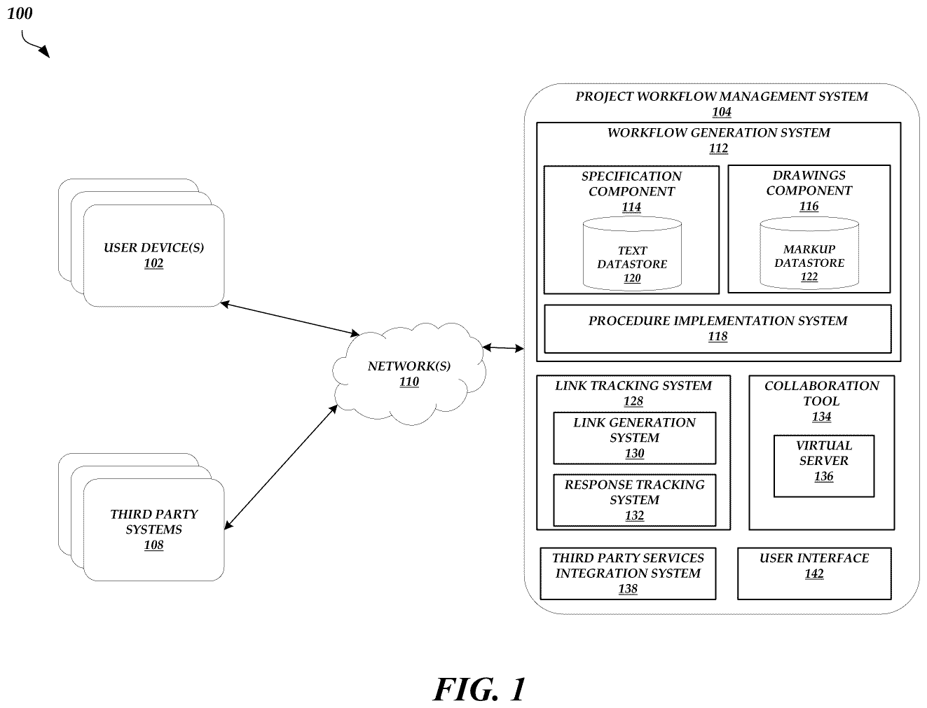

FIG. 1 is a schematic block diagram of an example network environment 100 in which a project workflow management system 104 can operate, according to various aspects of the present disclosure. The network environment 100 includes user device(s) 102, project workflow management system 104, third party systems 108, all in communication with each other through network 110.

In various aspects, communication among the various components of the example network environment 100 can be accomplished via any suitable device, systems, methods, and/or the like. For example, the project workflow management system 104 can communicate with the user device(s) 102, the third party systems 108 via any combination of the network 110 or any other wired or wireless communications networks, method (e.g., Bluetooth, WiFi, infrared, cellular, and/or the like), and/or any combination of the foregoing or the like. As further described below, network 110 can comprise, for example, one or more internal or external networks, the Internet, and/or the like. In addition, the project workflow management system 104 can include various hardware components and software components and can provide functionality as described further herein.

Further details and examples regarding the implementation, operation, and functionality of the various components of the project workflow management system 104 and the example network environment 100 are described herein in reference to various figures.

a. Network

The network 110 can include any appropriate network, including wired network, wireless network, or combination thereof. For example, network 110 can be a personal area network, local area network, wide area network, cable network, satellite network, cellular network, or any other such network or combination thereof. As a further example, the network 110 can be a publicly accessible network of linked networks, possibly operated by various distinct parties, such as the Internet. Protocols and components for communicating via the Internet or any other types of communication networks are known to those skilled in the art of computer communications and thus, need not be described in more detail herein. In some implementations, the network 110 can be a private or semi-private network, such as a corporate or university intranet. The network 110 can include one or more wireless networks, such as a Global System for Mobile Communications (GSM) network, a Code Division Multiple Access (CDMA) network, a Long-Term Evolution (LTE) network, C-band, mmWave, sub-6 GHz, or any other type of wireless network. The network 110 can use protocols and components for communicating via the Internet or any of the other aforementioned types of networks. For example, the protocols used by the network 110 can include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art of computer communications and thus, need not be described in more detail herein.

In various implementations, the network 110 can represent a network that can be local to a particular organization, e.g., a private or semi-private network, such as a corporate or university intranet. In some implementations, user device(s) 102 can communicate via the network 110 without traversing an external network, such as the Internet. In some implementations, devices connected via the network 110 can be walled off from accessing the Internet. As an example, the network 110 may not be connected to the Internet. Accordingly, e.g., the user device(s) 102 can communicate with the project workflow management system 104 directly (via wired or wireless communications) or via the network 110, without using the Internet. Thus, even if the network 110 or the Internet is down, the project workflow management system 104 can continue to communicate and function via direct communications (and/or via the network 110).

b. Example User Devices

User device(s) 102 illustratively correspond to any computing device that provides a means for a user or admin to interact with components of network environment 100 (e.g., the project workflow management system 104, the third party systems 108, or the like). For example, a user, with user device(s) 102, can interact with systems of the project workflow management system 104, such as the workflow generation system 112 and other tools, to manage and access documents relevant to a construction project. In some examples, the project workflow management system 104 can be implemented on device(s) 102. Of course, other activities can also be performed by a user with a user device(s) 102. User device(s) 102 can include user interfaces or dashboards that connect a user with a machine, system, or another device (e.g., another user device 102). In various implementations, user device(s) 102 include computer devices with a display and a mechanism for user input (e.g., mouse, keyboard, voice recognition, touch screen, and/or the like). In various implementations, the user device(s) 102 include desktops, tablets, e-readers, servers, wearable device, laptops, smartphones, computers, gaming consoles, and the like. In some implementations, user device(s) 102 can access a cloud provider network via the network 110 to view or manage their data and computing resources, as well as to use websites and/or applications hosted by the cloud provider network. Elements of the cloud provider network can also act as clients to other elements of that network. Thus, user device(s) 102 can generally refer to any device accessing a network-accessible service as a client of that service.

c. Project Workflow Management System

Within the network environment 100, the project workflow management system 104 operates to manage workflows for a construction or building project based on a custom specification and the project's accompanying drawings. In some implementations, the project workflow management system 104 includes various systems and tools to manage the workflow progress, status, and execution (e.g., by various parties) of the building project. In addition, the various systems and tools of the project workflow management system 104 can be accessed (e.g., via user device(s) 102) by team members (and other parties with permission) in completing steps of the project workflow.

In some implementations, the project workflow management system 104 can be implemented on a cloud provider network (e.g., that can be accessed by user device(s) 102 over a network 110). A cloud provider network (sometimes referred to simply as a “cloud”), refers to a pool of network-accessible computing resources (such as compute, storage, and networking resources, applications, and services), which can be virtualized or bare-metal. The cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

The cloud provider network can implement various computing resources or services, which can include a virtual compute service, data processing service(s) (e.g., map reduce, data flow, and/or other large scale data processing techniques), data storage services (e.g., object storage services, block-based storage services, or data warehouse storage services) and/or any other type of network based services (which can include various other types of storage, processing, analysis, communication, event handling, visualization, and security services). The resources required to support the operations of such services (e.g., compute and storage resources) can be provisioned in an account associated with the cloud provider, in contrast to resources requested by users of the cloud provider network, which can be provisioned in user accounts. The cloud provider network can include sets of host computing devices, where each set can represent a logical group of devices, such as a physical “rack” of devices. Each computing device can support one or more hosted machine instances that can be virtual machine instances, representing virtualized hardware supporting, e.g., an operating system and applications. Hosted machine instances can further represent “bare metal” instances, whereby a portion of the computing resources of the computing device directly support (without virtualization) the machine instance. In some cases, a machine instance can be created and maintained on behalf of a client. For example, a client can utilize a client computing device to request creation of a machine instance executing client-defined software. In other cases, machine instances can implement functionality of the cloud provider network itself. For example, machine instances can correspond to block storage servers, object storage servers, or compute servers that in term provide block storage, object storage, or compute, respectively, to client computing devices. While block storage, object storage, and compute are example services, machine instances can additionally or alternatively represent domain name services (“DNS”) servers, relational database servers, servers providing serverless computing services, and other server services for supporting on-demand cloud computing platforms. Each host computing device includes hardware computer memory and/or processors, an operating system that provides executable program instructions for the general administration and operation of that server, and a computer-readable medium storing instructions that, when executed by a processor of the server, allow the server to perform its intended functions. Furthermore, the cloud provider network can include other computing devices facilitating operation of the host computing devices, such as data stores to store account information, computing devices to implement logging, monitoring, and billing services, etc.

In some implementations, the cloud provider network can provide on-demand, scalable computing platforms to users through the network 110, for example allowing users to have at their disposal scalable “virtual computing devices” via their use instances or services provided by such instances. These virtual computing devices have attributes of a personal computing device including hardware (various types of processors, local memory, random access memory (“RAM”), hard-disk and/or solid-state drive (“SSD”) storage), a choice of operating systems, networking capabilities, and pre-loaded application software. Each virtual computing device can also virtualize its console input and output (“I/O”) (e.g., keyboard, display, and mouse). This virtualization allows users to connect to their virtual computing device using a computer application such as a browser, application programming interface, software development kit, or the like, in order to configure and use their virtual computing device just as they would a personal computing device. Unlike personal computing devices, which possess a fixed quantity of hardware resources available to the user, the hardware associated with the virtual computing devices can be scaled up or down depending upon the resources the user requires. Users can choose to deploy their virtual computing systems to provide network-based services for their own use and/or for use by their customers or clients.

As shown in FIG. 1, the project workflow management system 104 can include one or more of the following components: workflow generation system 112, link tracking system 128, collaboration tool 134, third party services integration system 138, and user interface 142.

i. Workflow Generation System

Workflow generation system 112 can be configured to generate and manage workflows for a construction or building project based on documents relevant to the project. For example, building projects typically include a specification document and accompanying drawings, among other documents. The workflow generation system 112 can, in some implementations, parse the specification and drawings to extract and implement procedures (e.g., rules, events, tasks, steps) that guide the workflow of the project. As shown in FIG. 1, the workflow generation system 112 can include a specification component 114, a drawings component 116, and a procedure implementation system 118.

### A. Specification Component

Specification component 114 can be configured to parse the contents of a specification document related to a project and integrate the contents within a workflow generated by the workflow generation system 112. The specification document can include a written document describing the: scope of the work that is needed, recommended or required materials, methods of constructing or manufacturing, quality of workmanship (e.g., such as an industry standard or certification level) of a project, or the like. For example, methods of construction or manufacture can include any specific instruction, guidance, rule, or process related to constructing of a project (e.g., a building, or the like). In addition, the specification document can be any applicable file format, such as PDF, TXT, PNG, JPEG, DOC, DOCX, XLS, XLSX, or the like. The specification document is a document (e.g., PDF), or series of documents, comprising one or more pages.

Specification component 114 can, in some implementations, receive, retrieve, or access a document, such as a specification related to a building or construction project. For example, the document can be uploaded by a user of the user device(s) 102 to the project workflow management system 104 (e.g., via or to the specification component 114). In some implementations, the specification component 114 can receive, download, or otherwise access the document stored on any component of the network environment 100 and accessible via the network 110.

In some implementations, the specification component 114 can parse the content of the specification document. In some implementations, the specification component 114 can utilize an optical character recognition (OCR) service or system, or any other object, character, or language recognition system to extract readable text from the document. In addition, the specification component 114 can be configured to identify content of the specification document. For example, the specification component 114 can identify features of the specification document, such as a table of contents, page numbers, drawing numbers, division numbers, section numbers. In addition, the specification component 114 can extract events relating to the project (e.g., such as submittals, etc.). In some implementations, the specification component 114 can identify submittals in each division, section, subsection, and the like.

In some implementations, the specification component 114 can implement machine learning (“ML”) algorithms, artificial intelligence (“AI”) algorithms, and/or any other types of algorithms (generally collectively referred to herein as “AI/ML algorithms”, “AI/ML models”, or simply as “ML algorithms”, “ML models”, and/or the like) that may, for example, implement models that are executed by one or more processors to parse the content of a specification document. Having an ML model to identify content of a specification document can advantageously provide significant improvements as compared to conventional systems because detected text and/or the associated meaning of any detected text can be literally ambiguous or literally unclear but can in fact be relatively clear to a person in the industry or based on related projects (e.g., that the ML model can be trained on), such that an ML model can automatically identify and automatically resolve the ambiguity where a traditional system cannot.

The specification component 114 can, such as by using an AI model, parse the entirety of a specification document and identify each section (e.g., as identified by the specification number in the table of contents). In some implementations, the specification component 114 can divide the specification document into multiple documents or files based on the identified sections (“section document”). For example, a PDF or Microsoft Word specification document can be divided into multiple section documents (e.g., PDF or Microsoft Word files), each file comprising a specific portion of the specification document corresponding to a particular section (e.g., a single/separate file can be generated for “Mockups” identified by specification number 01 43 39). In some implementations, each page of the section document can comprise the pages of the specification document corresponding to a series of pages corresponding to an identified section in the specification document.

In addition, for example, each section document can be associated with certain users of the project workflow management system 104. In some implementations, users associated with specific section documents (e.g., associated, assigned, or the like) can receive notifications, alerts, emails, or the like when an update to procedures or events corresponding to the specific section occur. For example, if a user (e.g., a contractor) submits a question, such as via a comment or message within the project workflow management system 104 and relating to the content in the specific section document to which one or more other users are assigned (e.g., a project manager or architect), all users associated with the section document (e.g., the project manager or architect) can be alerted and or copied on a communication chain (e.g., such as via a Smart Link). In some implementations, a user can associate certain users of the project workflow management system 104 to certain section documents. In addition, in some implementations, certain users of the project workflow management system 104 can be automatically associated with section documents based on their designated role for the project (e.g., the architect can be listed as the default contact, an electrical engineer can be assigned automatically to sections corresponding to electrical installations or components, or the like).

In some implementations, the specification component 114 can store the identified data from the specification document into one or more datastores, such as the text datastore 120. For example, the extracted data can be stored as an index, a table, or other relevant data storage format. In some examples, the identified data from the specification document can be organized. For example, identified information in the index can be organized according to the table of contents of the document. In some examples, the index can be displayed in an interface, such as in the user interface 142, and be accessible to a user of the project workflow management system 104. The identified data of the specification document stored in the text datastore 120 can be accessed by other components of the workflow generation system 112 and other components of the project workflow management system 104. For example, the procedure implementation system 118 can access data stored in the text datastore 120 to generate procedures to be implemented in the project workflow.

As noted herein, in some implementations, the specification component 114 can identify and store submittals within the specification document. In addition, the specification component 114 can, such as by using an AI model, parse the entire specification document and identify submittals. As noted herein, the specification component 114 can be configured to utilize an OCR tool to extract readable text and characters from the specification document. In some implementations, the AI model can be used instead or in addition to an OCR tool to parse or process a document, such as a specification document. In some implementations, the specification component 114 can, using the AI model, identify (e.g., after or in conjunction with utilizing OCR tools), for each identified submittal, a section location within the specification document and associated requirements for each submittal. For example, the AI model can parse a “door hardware” section of the specification document (e.g., identified by 08 71 00) and identify (1) a number of submittals that need to be completed in that section, and, in some implementations, (2) any requirements of each of the submittals such as types of data/documents that need to be uploaded or submitted, or the like. The AI model can, in some implementations, build a tree or network to track the location of each identified submittal within the specification document. In some examples, the AI model can identify submittals within each section document in building the tree or network to track the location of each identified submittal. In some implementations, the AI model can be trained using supervised learning and/or unsupervised learning methodologies (e.g., as described further herein). For example, inputs used to train the AI model can include labeled, unlabeled, or a combination of labeled and unlabeled data (such as previously used specification documents) as well as general rules programmed or updated manually, automatically (e.g., as determined by the AI model), or a combination (e.g., a portion if). General rules, for example, can include guidance to the AI model as to where to find certain requirements or sections and/or what portion of a specific requirement to incorporate into the workflow (e.g., per the procedure implementation system 118).

The specification component 114 can store the list of submittals in a database. In some implementations, the list of submittals can be viewed or accessed by a user of the project workflow management system 104, such as via the user interface 142, to understand what items need to be submitted or resolved for a particular project without necessarily opening the specification document. In addition, in some implementations, the specification component 114 can identify submittals within each section document.

The specification component 114 can, for each submittal, identify information relating to the submittal. For example, the AI model (e.g., trained on a custom data set) can be used to identify what type of information is required to satisfy, fulfill, or otherwise complete an information submittal (e.g., product data, schedule request, shop drawings), relevant parties, and the like. In addition, the AI model can be used by the specification component 114 to identify relevant deadlines, due dates, etc. corresponding to the submittal. In some implementations, the specification document location information and submittal information parsed by the AI model can be integrated as steps or procedures into the project workflow management system 104, such as by the procedure implementation system 118.

In some implementations, the AI model utilized by the specification component 114 can be trained to output submittal information to be integrated into the project workflow management system 104 as procedures. For example, the specification component 114 can perform the training asynchronously (e.g., prior to or concurrently with) generation of procedures. To perform the training, the specification component 114 can process, access, or obtain training data formed at least in part from specification documents, manuals, and other specification-type materials. For example, training data can include hundreds, thousands, millions, or more project manuals or specifications. In some implementations, some or all of the training documents can be labeled. For example, labels can identify various locations or appearances associated with requirements or required procedures with corresponding information, such as due date(s), relevant part(ies), requested information, or the like. In addition, labels can include various rules, queries, or procedures that a trained AI should be configured to parse and integrate into the project workflow management system 104 automatically, manually, or a combination. In some implementations, some or all of the training documents can be unlabeled such that the AI model can train to identify various locations or appearances associated with requirements or required procedures with corresponding information, such as due date(s), relevant part(ies), requested information, or the like. The identified requirements or required procedures can then be implemented as rules, queries, or procedures into the project workflow management system 104 automatically, manually, or a combination.

### B. Drawings Component

Drawings component 116 can also be configured to parse the contents of a drawings file compiling a set of design, construction, or similar drawings related to a project and integrate the contents within a workflow generated by the workflow generation system 112. The file can include any drawings, floorplans, blueprints, designs, diagrams, or any document that illustrates design decisions for a specific building project. In addition, the specification document can be any applicable file format, such as PDF, PNG, JPEG, AI, TIFF, PSD, EPS, INDD, RAW, DOC, DOCX, XLS, XLSX, etc.

The drawings component 116 can, in some implementations, access a document, such as a drawings specification document related to a building or construction project. For example, the document can be uploaded by a user of the user device(s) 102 to the drawings component 116. In some examples, the drawings component 116 can receive, download, or otherwise access the document stored on any component of the network environment 100 and accessible via the network 110.

In some implementations, the drawings component 116 can parse the content of the drawings file. In some implementations, the drawings component 116 can utilize an optical character recognition (OCR) service or system, or any other natural language recognition system to extract readable text from the document. The drawings component 116 can be displayed to a user in a user interface, such as the user interface 142. In addition, the drawings component 116 can receive a user input identifying features on the drawings file. For example, the drawings component 116 can receive a markup or other indicator on the drawings file corresponding to a certain feature on the drawings file, such as a page number, a drawing title, etc. In addition, the drawings component 116 can be configured to extract content of the drawings file. For example, the drawings component 116 can identify and extract features relating to the layout or design of the drawings. In addition, the drawings component 116 can identify and extract events relating to the project.

In some implementations, the drawings component 116 can implement AI/ML algorithms or models that may, for example, implement models that are executed by one or more processors to parse the content of a set of design or construction drawing, or similar. Having an ML model to identify content of a drawings file can advantageously provide significant improvements as compared to conventional systems because detected text or features, and/or the associated meaning or locations of any detected text or features can be literally ambiguous or literally unclear but can in fact be relatively clear to a person in the industry or based on related projects (e.g., that the ML model can be trained on), such that an ML model can automatically identify (e.g., the location where it should be located on a specific page of a specific drawing) and automatically resolve the ambiguity where a traditional image processing system cannot.

In some implementations, the drawings component 116 can store the extracted information from the drawings file into a datastore, such as the markup datastore 122. For example, the extracted information can be stored in an index, a table, or other relevant data storage component. In some examples, the extracted information from the document can be organized. For example, extracted information in the index can be organized according to the table of contents of the document. In some examples, the index can be displayed in an interface, such as in the user interface 142, and be accessible to a user of the project workflow management system 104. The extracted information of the drawings file stored in the markup datastore 122 can be accessed by other components of the workflow generation system 112 and other components of the project workflow management system 104. For example, the procedure implementation system 118 can access extracted information stored in the markup datastore 122 to generate procedures to be implemented in the project workflow.

In addition, the drawings component 116 can, such as by using an AI model, parse the entire drawings file and determine procedures to be implemented into the project workflow management system 104. As noted herein, the drawings component 116 can be configured to utilize an OCR tool to extract readable text and characters from the drawings file. In some implementations, the AI model can be used instead or in addition to an OCR tool to parse or process a document, such as a drawings file. In some implementations, the drawings component 116 can, using the AI model, identify (e.g., after or in conjunction with utilizing OCR tools), for each drawing file, a section location within the drawings file. In some implementations, the drawings component 116 can divide or apportion a drawings file into separate pages or sections (e.g., a single PDF page). The AI model can, in some implementations, build a tree or network to track the location of each identified drawing or feature within the drawings file. In some examples, the AI model can identify procedures within each section document in building the tree or network to track the location of each identified procedure. The drawings component 116, such as via the AI model, can, for each drawing or feature of the drawings file, identify information relating to the feature. In addition, the AI model utilized by the drawings component 116 can identify relevant deadlines, due dates, etc. corresponding to the submittal. In some implementations, the specification document location information and submittal information parsed by the AI model can be integrated as procedures into the project workflow management system 104, such as by the procedure implementation system 118.

In some implementations, the AI model can be trained using supervised learning and/or unsupervised learning methodologies (e.g., as described further herein). For example, inputs used to train the AI model can include labeled, unlabeled, or a combination of labeled and unlabeled data (such as previously used specification documents) as well as general rules programmed or updated manually, automatically (e.g., as determined by the AI model), or a combination (e.g., a portion if). General rules, for example, can include guidance to the AI model as to where to find certain requirements or sections and/or what portion of a specific requirement to incorporate into the workflow (e.g., per the procedure implementation system 118).

In some implementations, the AI model utilized by the drawings component 116 can be trained to output submittal or drawing information to be integrated into the project workflow management system 104 as procedures. For example, the drawings component 116 can perform the training asynchronously (e.g., prior to or concurrently with) generation of procedures. To perform the training, the specification component 114 can process, access, or obtain training data formed at least in part from drawing files, figures, blueprints, and other drawing-type materials. For example, training data can include hundreds, thousands, millions, or more drawing files. In some implementations, some or all of the training documents can be labeled. For example, labels can identify various locations or appearances associated with requirements or required procedures with corresponding information, such as drawing type, drawing title, due date(s), relevant part(ies), requested information, or the like. In addition, labels can include various rules, queries, or procedures that a trained AI should be configured to parse and integrate into the project workflow management system 104 automatically, manually, or a combination. In some implementations, some or all of the training documents can be unlabeled such that the AI model can train to identify various locations or appearances associated with requirements or required procedures with corresponding information, such as due date(s), relevant part(ies), requested information, or the like. The identified requirements or required procedures can then be implemented as rules, queries, or procedures into the project workflow management system 104 automatically, manually, or a combination.

### C. Procedure Implementation System

Procedure implementation system 118 can be configured to generate procedures to be implemented in the project workflow based on the extracted information from the specification component 114 or the drawings component 116. In some implementations, procedure implementation system 118 can generate procedures to be implemented in the workflow based on additional documents apart from the specification (or manuals) and the drawings.

In some implementations, the specification component 114 can also identify submittals from the specification document. In some implementations, the specification component 114 can identify submittals from each of the section documents. In some implementations, the specification component 114 can label each identified submittal by its specification number. The workflow management system can be configured to receive an upload of one or more files designated for a particular required document as determined by the specification component 114. In some implementations, the procedure implementation system 118 may receive an indication of each submittal from the specification component 114 for integration into the project workflow management system 104. For example, the list of submittals can be presented to a user of the project workflow management system 104 via the user interface 142. In some implementations, the procedure implementation system 118 can track the progress of each submittal. For example, the procedure implementation system 118 can track and maintain a status, an anticipated initial submission date, a final due date, a responsible user (e.g., a user who may be a point person or assigned manager of the submittal), and the like. In some implementations, each submittal can be identified by a unique submittal number.

In some implementations, the procedure implementation system 118 can access extracted data stored in the text datastore 120. For example, the procedure implementation system 118 can access extracted data relating to action submittals, information submittals, due dates, deadlines, or other miscellaneous tasks that are required for completion of the project. In some implementations, a specification document can contain the following submittal: “Obtain all necessary permits and approvals before use of torches.” The procedure implementation system 118 can, in response to this information, identify project steps or tasks that include the use of torches (e.g., tasks designated to welders or contractors). The procedure implementation system 118 can insert a “permit check” step that confirms whether all necessary permits and approvals have been submitted before physical torch work is performed. This check can be in the form of a notification or reminder to affected or assigned parties, such as via email and/or a smart link, to prompt the parties to submit or execute the necessary forms, documents, permits, or information to satisfy the procedure. For example, smart links can be sent via the link tracking system 128 to various parties to access portions of the project workflow management system 104. In some implementations, the custom programmed links can be sent to a person prompting the person to upload or execute specific documents, such as certification forms etc. In some implementations, smart links can allow recipients to access portions of the project workflow management system without creation of an account with the project workflow management system. In some cases, the procedure implementation system 118 can generate an event, reminder, smart link, email, text message, or other notification (such as a push notification) corresponding to the extracted submittal information (e.g., in response to an action submittal requiring submission of a report, an approval request by a certain party, an upcoming deadline.

In some implementations, the procedure implementation system 118 can implement AI/ML algorithms or models that may, for example, implement models that are executed by one or more processors to generate, program, create, and/or implement a set of procedures based at least in part on the results output from the specification component 114 and/or the drawings component 116. For example, having an ML model to determine which procedures to implement and to automatically implement and execute the determined procedures can advantageously provide significant improvements as compared to conventional systems because such conventional systems require manual input and programming that a system employing the use of AI/ML would not generally require.

ii. Link Tracking System

Link tracking system 128 can be configured to generate and manage links (such as smart links) that provide access to the project workflow management system 104 and components thereof. As noted herein, a building or construction project can involve numerous team members (e.g., contractors, subcontractors, engineers, architects, or the like). In addition, the project can involve parties who are not considered central to the project but are still relevant for certain events within the workflow. For example, subcontractors such as an environmental expert or specialist completing a commissioned report on environmental conditions surrounding the project can have a small role in the overall completion of a building project. As such, the subcontractor cannot need full access to the entire project workflow management system 104 nor all the data stored in or by the project workflow management system 104. Rather, the subcontractor can only need access to a specific function of the project workflow management system 104 (e.g., such as to upload and review environmental reports, or other limited features or data). In some implementations, to provide access to the subcontractor, the link tracking system 128 can be configured to generate and manage a link (e.g., smart link), to be sent to a user, such as the subcontractor, so that the user can access or interact with the project workflow management system 104.

In some implementations, the link tracking system 128 or components thereof can implement AI/ML algorithms or models that may, for example, implement models that are executed by one or more processors to generate and/or track interactions with any generated links, such as smart links. For example, having an ML model to generate a specific link that can track various uses by various users can advantageously provide significant improvements as compared to conventional systems because such conventional systems would not be able to customize such links automatically for various situations. For example, an AI/ML model can be used to generate a smart link that performs the following example functions and/or is generated based on one of the following examples: (1) usable for a limited amount of time, (2) is usable during certain hours of the day or on certain days of the week, (3) links to different features or pages based on the time of day or day of the week the link is selected, (4) lead to different pages based on the user profile, such as age, geographic location, IP address, device ID, or previous interactions with the website or application tied to any detected identifier, (5) adapt to current events or trends (e.g., if there is a holiday or office closure event, the link could automatically direct users to a specific page without manual intervention), (6) change its functionality based on the user's behavior, such as if they have visited certain pages, (7) adapt its destination or functionality based on the user's device, providing a tailored experience for mobile, tablet, or desktop users, (8) change the content it links to after it expires, (9) depending on the language settings of the user's device, the smart link could direct to a language-specific version of the site, (10) depending on recipients of the smart link, (11) depending on the project or task related to the reason the smart link is generated (e.g., if a file should be uploaded for something to be approved but the approval is already provided, then the link can deactivate or point to a different page indicating the file is no longer needed), (12) or the like.

### A. Link Generation System

In some implementations, the link generation system 130 can be configured to generate a link to gain access to the project workflow management system 104. For example, a user can define permissions or security levels that apply to recipients of a generated link. For example, permissions can include the ability to view documents, edit and revise documents, create documents, generate new permissions, etc. In some implementations, a recipient of a link might be limited to only uploading documents to the project workflow management system 104 (e.g., to submit a requested report or permit). To generate a link, the link generation system 130 can be configured to create a link, hyperlink, or other digital reference with a unique identifier that permits an access instance to a recipient. In some implementations, the link generation system 130 can generate an access key to which a recipient can access a portion of the project workflow management system 104 (e.g., so that preconfigured permissions are applied correctly). In some implementations, the link generation system 130 can generate a unique link, such as a URL, based on specific documents and specific recipient(s). In some implementations, each document uploaded or a part of a project in the project workflow management system 104 is assigned a unique identifier or ID. In some implementations, each user registered with the project workflow management system 104 can be assigned a unique identifier or ID as well. For example, a user can, through the link generation system 130, request to generate a link to share an electrical schematic with an electrician registered with the project workflow management system 104. The link generation system 130 can generate a unique URL with embedded information relating to the electrical schematic's unique ID and the electrician's unique ID. The generated URL can comprise the following, for example: “https://www.companyname.com/a25e88dzb11123977a?user=jkabwdyi83j392.” In this example, “a25e88dzb 11123977a” would correspond to the electrical schematic unique ID and “jkabwdyi83j392” would correspond to the recipient's unique ID. In some implementations, the link generation system 130 can provide an option for a user or sender to send an email or text message to a recipient with an embedded link that is configured to track interactions with the link. In some implementations, the link generation system 130 can track the email to a recipient with an imbedded image that is configured to track interactions with the email. In some implementations, the link generation system 130 can provide an option for a user to copy and paste the generated link to share with a recipient.

### B. Response Tracking System

In addition to the link generation system 130, the link tracking system 128 includes a response tracking system 132. In some implementations, the response tracking system 132 can be configured to monitor the status of generated links. For example, the response tracking system 132 can track whether a recipient of a generated link has clicked on the link, accessed the project workflow management system 104, and/or completed an action requested (e.g., such as by providing content or files to the project workflow management system 104). In some implementations, the response tracking system 132 can send automated notifications or reminders to team members, recipients, etc. such as, for example, when the response tracking system 132 has not detected activity with the generated link or when the response tracking system 132 detects completion of an action.

iii. Collaboration Tool

The project workflow management system 104 can include additional applications or tools accessible by users, such as tool 134. Collaboration tool 134 can be any application, program, software, etc. that can be used by team members for completing a procedure or project. In one example, a first collaboration tool can be configured to allow team members to organize and collaborate on documents, such as PDF files of drawings, blueprints, and the like. In this example, the first collaboration tool includes a virtual server 136 configured to host and receive files to be edited or otherwise processed (e.g., flattened). In some examples, the collaboration tool 134 can be utilized to allow multiple users and/or system to access a single license (e.g., account) for collaboration programs to perform one or more functions. In some implementations, the first collaboration tool can be configured to receive instructions, via a user, to edit a document, such as a PDF, over the virtual server 136. In this example, when the collaboration tool 134 receives a “save” or “close” instruction pertaining to a document, the collaboration tool 134 can move the file into a flattening instance and export the document into the project workflow management system 104. By doing this, the collaboration tool 134 can seamlessly integrate within the project workflow management system 104 and provide additional tools for collaboration on documents within the project among team members. For instance, a plurality of users can interact with the project workflow management system 104 all at the same time and benefit from the license located on the virtual server 136 without having to have a license for themselves so that they can, for example: upload or provide access to a file, have it processed (e.g., by the virtual server 136 utilizing a single license), and receive an output based on processing done on the virtual server 136.

iv. Third Party Services Integration System

Third party services integration system 138 can be configured to connect users of the project workflow management system 104 to additional services and programs hosted by third parties. For example, third party programs can include any additional service related to project workflows, such as bidding services and/or portals and other project management programs. For example, bidding portals accessible via the third party services integration system 138 can be configured to provide an interface through which parties, such as owners, project managers, etc. can post proposals and receive bids from contractors, subcontractors, and other professionals. In some examples, users already registered with the project workflow management system 104 can access the third party services integration system 138 to access bidding services. In some examples, the third party services integration system 138 can communicate with the third party systems 108 via API(s). In some implementations, the third party services integration system 138 can connect users of the project to additional tools for use within the project.

v. User Interface

User interface 142 can be any user-facing interface or platform, such as a graphical user interface (GUI), through which a user of user device(s) can interact with the project workflow management system 104. In some implementations, the user interface 142 can be a portal, website, application, mobile application, etc. through which a user can access components or features of the project workflow management system 104. For example, through the user interface 142, team members can upload, interact with, and/or access documents related to a project. In addition, team members can generate smart links via the link tracking system (e.g., “smart links”), which can be displayed on the user interface 143. In addition, users that are not team members can access certain areas and tools of the project workflow management system 104 through the user interface 142.

d. Third Party Systems

Third party systems 108 can include additional services and programs hosted by third parties outside of the project workflow management system. For example, the third party systems 108 can include any additional collaboration tools or programs, editing programs, revision programs, design programs, etc. that team members of a building project may desire to use. In some examples, the project workflow management system can be communicatively coupled to the third party systems 108, via the third party services integration system 138 via API(s) over the network 110. In some implementations, API(s) can include any software or component configured to connect programs or services within the network environment 100. For example, the API(s) can include any system that offers tools or programs accessible to users of the project workflow management system 104. For example, the project workflow management system 104 can communicate with third party system 108 via API(s) to access additional workflow tools.

In some examples, users of the project workflow management system 104 can access tools and other programs hosted by the third party systems 108. For example, documents can be sent between the third party systems 108. In some implementations, users who are not registered with the project workflow management system 104, additional team members of the third party systems 108 can be connected with the project workflow management system 104.

### II. Example Document Text Extraction Flow Diagram

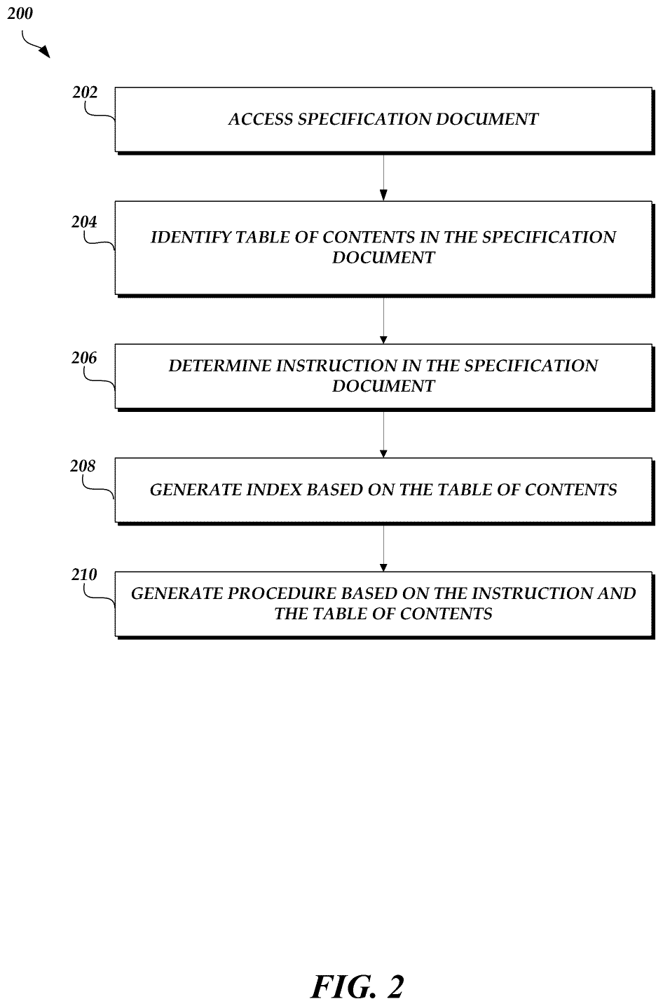

FIG. 2 is a flow diagram of an exemplary process 200 for parsing the contents of a file, such as a specification, related to a project and integrating the contents within a workflow, according to various aspects of the present disclosure. In some implementations, a process for parsing and integrating content of a specification document can be performed by the specification component 114, the procedure implementation system 118 of the workflow generation system 112, and/or other components of the project workflow management system 104.

At block 202, a specification document is accessed, received, or retrieved by the specification component 114. The specification document can include a written document describing the scope of the work that is needed, recommended or required materials, methods of constructing or manufacturing, and quality of workmanship (e.g., such as an industry standard or certification level) of a project. For example, methods of construction or manufacture can include any specific instruction, guidance, rule, or process related to constructing of a project (e.g., a building, or the like). In addition, the specification document can be any applicable file format, such as PDF, TXT, PNG, JPEG, DOC, DOCX, XLS, XLSX, etc. In some implementations, to access the specification document, the specification component 114 access a specification document that is uploaded by a user of the user device(s) 102 to the specification component 114. In some examples, the specification component 114 can receive, download, or otherwise access the specification document stored on any component of the network environment 100 and accessible via the network 110. In some examples, the specification component 114 can receive the document specification from the third party systems 108.

At block 204, a table of contents is identified in the specification document by the specification component 114. In some examples, the specification component 114 can parse the contents of the specification document to identify data corresponding to a table of contents. In some implementations, the specification document contains a table of contents proximate to the beginning of the specification document. In some implementations, the table of contents lists a number of divisions and sections as contained within the specification document. As noted above, divisions can relate to high-level industry classifications of construction work. For example, divisions in a typical specification can include concrete, masonry, wood, plastics and composites, thermal and moisture protection, openings, finishes, specialties, toilet and bath accessories, equipment, furniture, parking structures, electrical, food service, HVAC, plumbing, communications, earthwork, sewage, etc. Depending on the project, a specification document can contain a subset or at least a portion of these divisions, sections, and subdivisions, as noted by the table of contents. In addition, in some examples, each division detailed in the specification document can contain sections that correspond to detailed classifications of work within the division.

At block 206, a procedure in the specification document is determined by the procedure implementation system 118. In some examples, a procedure can include any text or language identifying a requirement to be completed for the project. In some examples, the procedure includes one of a request for an action to be executed by a third party, or a request for information from the third party. For example, procedures can include specific instructions or requirements for various parties, such as contractors, subcontractors, engineers, architects, etc. to follow during a project as defined or described in various divisions and sections. In some examples, some procedures or tasks, instructions, etc. can be referred to as “submittals,” and can be further defined as “action submittals,” “informational submittals,” or the like. Action submittals are typically required prior to purchase, manufacture, or delivery of materials to be incorporated into the project. In some cases, an action submittal can include specific actions that are required to be completed, such as submission of a materials sample to the lead designer. Information submittals can indicate information about the work to be done on the project, certifications, quality control purposes, etc. Typically, information submittals can be reviewed by design professionals or other coordinators to determine whether the contracted work and/or parties themselves are in compliance with contract documents. This can include submission of specific documentation, such as drawings, certificates, or other related documents. In some implementations, the specification component 114 can determine one or more instructions contained within the file.

In some implementations, determining the procedure includes searching the file based on a keyword by the specification component 114. The keyword can include any phrase, text, indicator, flag, that indicates a location within the file. For example, in typical construction specifications, each section can contain the phrase “END OF SECTION” appended to the end of the corresponding section. In some implementations, the specification component 114 can search the file for instances of “END OF SECTION” or similar phrases to determine the end of a first section and the start of a second section. In some examples, the presence of a keyword can indicate to the specification component 114 that a particular instruction is located within a division and section of the file.

In some implementations, the specification component 114 can store the extracted data from the specification document into a datastore, such as the text datastore 120. For example, the extracted data can be stored in an index, a table, or other relevant data storage component. In some examples, the extracted data from the document can be organized. For example, extracted data in the index can be organized according to the table of contents of the document.

In some implementations, the specification component 114 can, using an AI model, parse the entirety of the specification document and identify each individual section (e.g., as identified by the specification number in the table of contents). In some implementations, the specification component 114 can divide the specification document into multiple documents based on the individual section (“section document”). For example, a PDF-type specification document may be divided into multiple individual section documents (e.g., PDF files), each file containing a portion of the specification document corresponding to a particular individual section (e.g., a document for “Mockups” identified by specification number 01 43 39). Each page of the section document can contain the pages of the specification document corresponding to the individual section.

In addition, each section document may be associated with certain users of the project workflow management system 104. Users associated with certain section documents (e.g., associated, assigned) can receive notifications, alerts, emails, and the like whenever any update to procedures or events corresponding to the section occur. For example, if a user asks a question, such as via a comment or forum platform within the project workflow management system 104 and relating to the content in the section document, all users associated with the section document can be alerted and or copied on a communication chain. A user can manually associate certain users of the project workflow management system 104 to certain section document. In addition, certain users of the project workflow management system 104 can be automatically associated with section documents.

As noted herein, in some implementations, the specification component 114 can identify and store submittals within the specification document. In addition, the specification component 114 can, such as by using an AI model, parse the entire specification document and identify submittals. As noted herein, the specification component 114 can be configured to utilize an OCR tool to extract readable text and characters from the specification document. In some implementations, the AI model can be used instead or in addition to an OCR tool to parse or process a document, such as a specification document. In some implementations, the specification component 114 can, using the AI model, identify, for each identified submittal, a section location within the specification document and associated requirements for each submittal. For example, the AI model can parse a “door hardware” section of the specification document (e.g., identified by 08 71 00) and identify a number of submittals that need to be completed in that section, and, in some implementations, (2) any requirements of each of the submittals such as types of data/documents that need to be uploaded or submitted, or the like. The AI model can, in some implementations, build a tree or network to track the location of each identified submittal within the specification document. In some examples, the AI model can identify submittals within each section document in building the tree or network to track the location of each identified submittal. In some implementations, the AI model can be trained using supervised learning and/or unsupervised learning methodologies (e.g., as described further herein). For example, inputs used to train the AI model can include labeled, unlabeled, or a combination of labeled and unlabeled data (such as previously used specification documents) as well as general rules programmed or updated manually, automatically (e.g., as determined by the AI model), or a combination (e.g., a portion if). General rules, for example, can include guidance to the AI model as to where to find certain requirements or sections and/or what portion of a specific requirement to incorporate into the workflow (e.g., per the procedure implementation system 118).

The specification component 114 can store the list of submittals in a database. In some implementations, the list of submittals can be viewed or accessed by a user of the project workflow management system 104, such as via the user interface 142, to understand what items need to be submitted or resolved for a particular project without necessarily opening the specification document. In addition, in some implementations, the specification component 114 can identify submittals within each section document.

The specification component 114 can, for each submittal, identify information relating to the submittal. For example, the AI model (e.g., trained on a custom data set) can be used to identify what type of information is required to satisfy, fulfill, or otherwise complete an information submittal (e.g., product data, schedule request, shop drawings), relevant parties, and the like. In addition, the AI model can be used by the specification component 114 to identify relevant deadlines, due dates, etc. corresponding to the submittal. In some implementations, the specification document location information and submittal information parsed by the AI model can be integrated as steps or procedures into the project workflow management system 104, such as by the procedure implementation system 118.

In some implementations, the AI model utilized by the specification component 114 can be trained to output submittal information to be integrated into the project workflow management system 104 as procedures. For example, the specification component 114 can perform the training asynchronously (e.g., prior to or concurrently with) generation of procedures. To perform the training, the specification component 114 can process, access, or obtain training data formed at least in part from specification documents, manuals, and other specification-type materials. For example, training data can include hundreds, thousands, millions, or more project manuals or specifications. In some implementations, some or all of the training documents can be labeled. For example, labels can identify various locations or appearances associated with requirements or required procedures with corresponding information, such as due date(s), relevant part(ies), requested information, or the like. In addition, labels can include various rules, queries, or procedures that a trained AI should be configured to parse and integrate into the project workflow management system 104 automatically, manually, or a combination. In some implementations, some or all of the training documents can be unlabeled such that the AI model can train to identify various locations or appearances associated with requirements or required procedures with corresponding information, such as due date(s), relevant part(ies), requested information, or the like. The identified requirements or required procedures can then be implemented as rules, queries, or procedures into the project workflow management system 104 automatically, manually, or a combination.

At block 208, an index based on the table of contents is generated. In some implementations, the specification component 114 can generate the index based on the information of the table of contents. In some examples, the specification component 114 can access information extracted from the file, stored in the text datastore 120 for generation of the index. In some examples, the specification component 114 can organize the index based on the table of contents.

In some examples, the index can be displayed in an interface, such as in the user interface 142, and be accessible to a user of the project workflow management system 104. In some examples, a user can desire to update the index. For example, the project workflow management system 104 can receive a user input corresponding to a revision to the index, such as via the user interface on a display. In some examples, the revision can correspond to a change in the title, section number, page number, etc. In response to the user input, the index is updated.

In some examples, an error in the index can be identified, such as by the specification component 114 or the workflow generation system 112. In some examples, an error can refer to an inconsistency between the content of the file and the table of contents, a typographical error, a missing division, a missing section, etc. In some implementations, the specification component 114 can identify an error and generate a notification highlighting or prompting correction. In some implementations, an error confidence score can be calculated based on the error identified in the index. In some implementations, the error confidence score is calculated by any component of the workflow generation system 112 (e.g., 114). In some implementations, the error confidence score is calculated based on the likelihood that an identified error is an actual error in the specification document. In some implementations, an error confidence score can be calculated for each error identified in the index. In some implementations, errors with a confidence score at or above a threshold score are shown to the user, while errors with a confidence score less than a threshold are not shown to the user. In some implementations, errors can be highlighted to indicate to a user that an error in the specification document may exist. In some implementations, areas of the index that are missing information may be highlighted to a user.

At block 210, a procedure based on the instruction and the table of contents is generated. For example, a procedure implementation system (e.g., 118) can access extracted information relating to action submittals, information submittals, due dates, deadlines, or other miscellaneous tasks that are required for completion of the project. In one example, a specification contains the following submittal: “Obtain all necessary permits and approvals before use of torches.” The procedure implementation system can identify one or more project steps or tasks that include the use of torches (e.g., procedures designated to welders or contractors). The procedure implementation system can insert a “permit check” step that confirms whether all necessary permits and approvals have been submitted before physical torch work is performed. This check can be in the form of a notification or reminder to affected parties, such as via email, to prompt the parties to submit or execute the necessary forms. The procedure implementation system 118 can generate an event, reminder, or other notification corresponding to the extracted submittal information. In some implementations, generating the procedure further comprises generating a notification based on the instruction to a third party.

In some implementations, as noted herein, the specification component 114 can, using an AI model, identify submittals of the specification document, such as in each division, section, subsection, and the like. Also as noted herein, the specification component 114 may identify submittals from each of the section documents. In addition, the specification component 114 can label each submittal by its specification number. As noted herein, in some implementations, the specification component 114 can identify and store submittals within the specification document. In addition, the specification component 114 can, such as by using an AI model, parse the entire specification document and identify submittals. As noted herein, the specification component 114 can be configured to utilize an OCR tool to extract readable text and characters from the specification document. In some implementations, the AI model can be used instead or in addition to an OCR tool to parse or process a document, such as a specification document. In some implementations, the specification component 114 can, using the AI model, identify (e.g., after or in conjunction with utilizing OCR tools), for each identified submittal, a section location within the specification document and associated requirements for each submittal. For example, the AI model can parse a “door hardware” section of the specification document (e.g., identified by 08 71 00) and identify (1) a number of submittals that need to be completed in that section, and, in some implementations, (2) any requirements of each of the submittals such as types of data/documents that need to be uploaded or submitted, or the like. The AI model can, in some implementations, build a tree or network to track the location of each identified submittal within the specification document. In some examples, the AI model can identify submittals within each section document in building the tree or network to track the location of each identified submittal. In some implementations, the AI model can be trained using supervised learning and/or unsupervised learning methodologies (e.g., as described further herein). For example, inputs used to train the AI model can include labeled, unlabeled, or a combination of labeled and unlabeled data (such as previously used specification documents) as well as general rules programmed or updated manually, automatically (e.g., as determined by the AI model), or a combination (e.g., a portion if). General rules, for example, can include guidance to the AI model as to where to find certain requirements or sections and/or what portion of a specific requirement to incorporate into the workflow (e.g., per the procedure implementation system 118).

The specification component 114 can store the list of submittals in a database. In some implementations, the list of submittals can be viewed or accessed by a user of the project workflow management system 104, such as via the user interface 142, to understand what items need to be submitted or resolved for a particular project without necessarily opening the specification document. In addition, in some implementations, the specification component 114 can identify submittals within each section document.

The specification component 114 can, for each submittal, identify information relating to the submittal. For example, the AI model (e.g., trained on a custom data set) can be used to identify what type of information is required to satisfy, fulfill, or otherwise complete an information submittal (e.g., product data, schedule request, shop drawings), relevant parties, and the like. In addition, the AI model can be used by the specification component 114 to identify relevant deadlines, due dates, etc. corresponding to the submittal. In some implementations, the specification document location information and submittal information parsed by the AI model can be integrated as steps or procedures into the project workflow management system 104, such as by the procedure implementation system 118.

In some implementations, the AI model utilized by the specification component 114 can be trained to output submittal information to be integrated into the project workflow management system 104 as procedures. For example, the specification component 114 can perform the training asynchronously (e.g., prior to or concurrently with) generation of procedures. To perform the training, the specification component 114 can process, access, or obtain training data formed at least in part from specification documents, manuals, and other specification-type materials. For example, training data can include hundreds, thousands, millions, or more project manuals or specifications. In some implementations, some or all of the training documents can be labeled. For example, labels can identify various locations or appearances associated with requirements or required procedures with corresponding information, such as due date(s), relevant part(ies), requested information, or the like. In addition, labels can include various rules, queries, or procedures that a trained AI should be configured to parse and integrate into the project workflow management system 104 automatically, manually, or a combination. In some implementations, some or all of the training documents can be unlabeled such that the AI model can train to identify various locations or appearances associated with requirements or required procedures with corresponding information, such as due date(s), relevant part(ies), requested information, or the like. The identified requirements or required procedures can then be implemented as rules, queries, or procedures into the project workflow management system 104 automatically, manually, or a combination.

In some implementations, the procedure implementation system 118 may receive each submittal from the specification component 114 for integration into the project workflow management system 104. For example, the list of submittals may be presented to a user of the project workflow management system 104 via the user interface 142. In some implementations, the procedure implementation system 118 can track the progress of each submittal. For example, the procedure implementation system 118 can track and maintain a status, an anticipated initial submission date, a final due date, a responsible user (e.g., a user who may be a point person or assigned manager of the submittal), and the like. In some implementations, each submittal can be identified by a unique submittal number.

In some implementations, the process 200 can further comprise tracking progress of the procedure based on actions of the third party. This can include monitoring whether the third party, whether a team member, invited participant, recipient of a link, etc. has completed the procedure, such as uploading a certain document or providing approval, etc. In some implementations, depending on the tracked progress of the procedure, a status of the procedure can be updated. For example, if the third party completed the procedure, the status of the procedure can be updated to “completed.” In the case where the procedure is not yet completed, the workflow management system 104 can continue to send out notifications or reminders to the affected parties. In some examples, a procedure can include more than one steps, or procedures, to be accomplished by the third party, or in some cases, more than one third party. In this example, the process 200 can comprise tracking progress of each step of the procedure. For example, the actions of a first team member assigned to do a first procedure of the procedure can be monitored. Once the actions of the first team member have been completed, the process 200 can advance to tracking a second team member assigned to do a second procedure of the procedure, and so on.

### III. Example Document Feature Extraction Flow Diagram

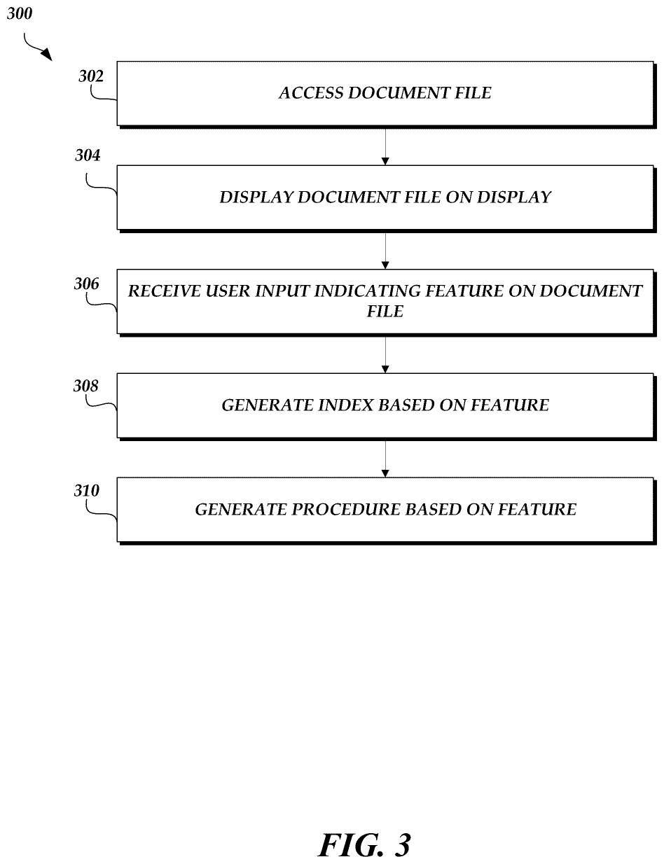

FIG. 3 is a flow diagram of an exemplary process 300 for parsing the contents of a file, such as a drawing file, related to a project and integrating the contents within a workflow, according to various aspects of the present disclosure. In some implementations, a process for parsing and integrating contents of a file can be performed by the drawings component 116, the procedure implementation system 118 of the workflow generation system 112 and other components of the project workflow management system 104.

At block 302, a file is accessed. In some implementations, the file can include any drawings, floorplans, blueprints, designs, diagrams, layout, or any document that illustrates design decisions for a specific building project. In addition, the file can be any applicable file format, such as PDF, PNG, JPEG, AI, TIFF, PSD, EPS, INDD, RAW, DOC, DOCX, XLS, XLSX, etc. In some implementations, to access the file, the drawings component 116 can access a document that is uploaded by a user of the user device(s) 102 to the drawings component 116. In some examples, the drawings component 116 can receive, download, or otherwise access the document stored on any component of the network environment 100 and accessible via the network 110.

At block 304, the file is displayed on a display. In some examples, the file can be displayed in an interface, such as in the user interface 142, and be accessible to a user of the project workflow management system 104. In some implementations, each page of the file can be displayed one at a time. In some implementations, a user of the project workflow management system 104 can navigate through each page of the file. In some implementations, multiple pages of the file can be displayed at the same time.

At block 306, user input indicating a feature on the file is received. For example, the drawings component 116 can receive a markup or other indicator on the file corresponding to a certain feature on the file, such as a page number, a drawing title, a title, etc. In some implementations, receiving the user input indicating the feature includes segmenting an area of the feature. In this example, the area includes a box, square, rectangle, circle, oval, triangle, or the like. In some implementations, a user can indicate the feature on the file by drawing a box or circle around the feature, highlighting the feature, clicking the feature, or otherwise selecting an area corresponding to the feature. For example, the user can draw a box around a page number of the file to indicate the page number as a feature of the file. In some implementations, more than one feature can be indicated on the file. To differentiate between the different features, different colors, highlights, textures, or other markup features can be used. For example, blue can be used for the first indication of a drawing number and orange used for a second indication of a drawing title.

In some implementations, the drawing component can parse the content of the file based on the user input indicating a feature. For example, in some implementations, the drawings component 116 can utilize an optical character recognition (OCR) service or system, or any other object, character, or language recognition system to extract readable text from the file based on the area of the feature segmented by the markup. In addition, the drawings component 116 can be configured to identify content of the specification document. For example, the drawings component 116 can identify features of the specification document, such as drawing numbers, page numbers, instructions, details, etc. In addition, the drawings component 116 can extract events relating to the project.

At block 308, an index based on the feature is generated. In some implementations, the process 300 can further include displaying the index on the display. In some examples, the index can be displayed in an interface, such as in the user interface 142, and be accessible to a user of the project workflow management system 104. In some examples, a user can desire to update the index. For example, the project workflow management system 104 can receive a user input corresponding to a revision to the index, such as via the user interface on a display. In some examples, the revision can correspond to a change in the title, section number, page number, etc. In response to the user input, the index is updated. In some implementations, errors can be identified. For example, errors can include an inconsistency between content of the specification and the table of contents, a typographical error, a missing division or section. In some implementations, an error confidence score can be calculated based on the error identified in the index. In some implementations, the error confidence score is calculated by any component of the workflow generation system 112 (e.g., 116). In some implementations, the error confidence score is calculated based on the likelihood that an identified error is an actual error in the file. In some implementations, an error confidence score can be calculated for each error identified in the index. In some implementations, errors with a confidence score at or above a threshold score are shown to the user, while errors with a confidence score less than a threshold are not shown to the user. In some implementations, errors can be highlighted to indicate to a user that an error in the file may exist. In some implementations, areas of the index that are missing information may be highlighted to a user.

At block 310, a procedure based on the feature is generated. As noted herein, the drawings component 116 can extract events relating to the project from the file. For example, the drawings component 116 can extract requirements or procedures by which certain elements of the project are required to be completed. In addition, the procedure implementation system 118 can cross-reference documents from the drawings component 116 and the specification component 114. In some implementations, the procedure implementation system 118 can be configured to generate a procedure based on a feature extracted from a file and information extracted from the specification document.

### IV. Example Document Text Extraction Screenshot Walkthrough

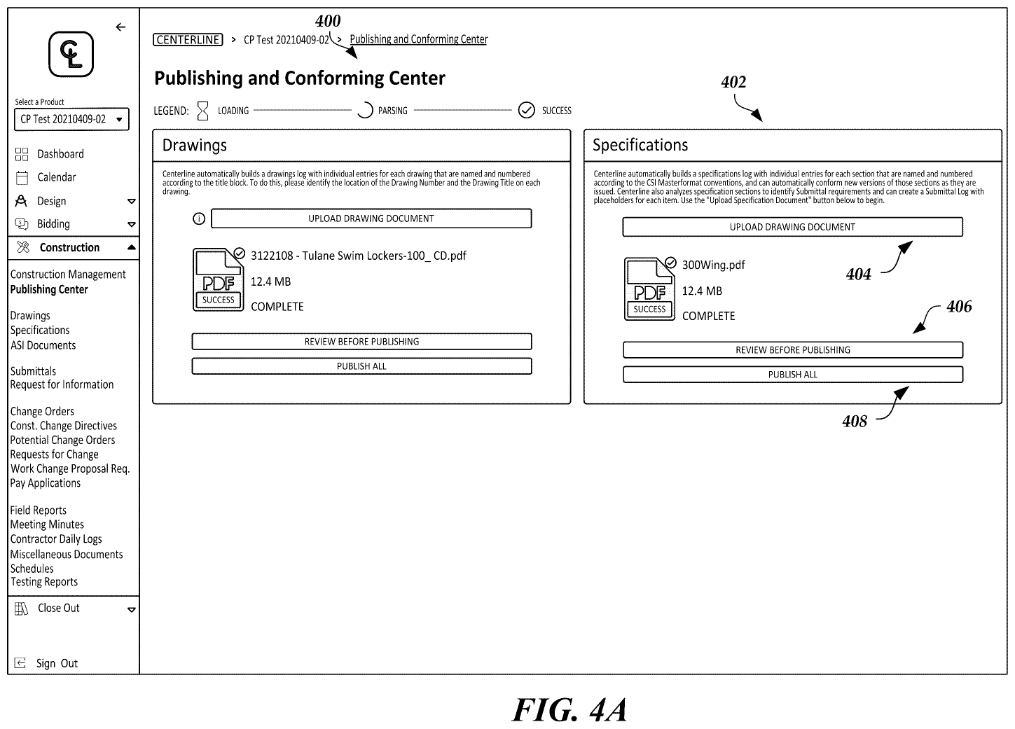

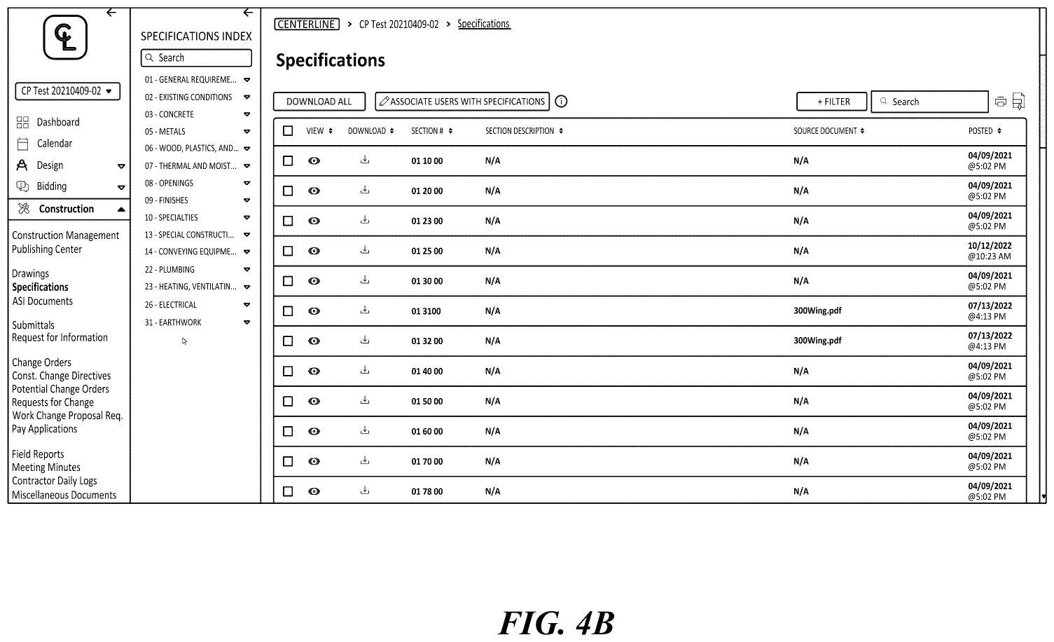

FIGS. 4A-4B illustrate example screenshots of a file feature extraction tool within an example project workflow management system 104.

FIG. 4A illustrates an example interface 400 through which a user can interact with the workflow generation system 112, specifically the specification component 114. As shown in FIG. 4A, a user can interact with various user interface components within the user interface 142 to access the specification component 114 within a specifications area 402.

In some implementations, to upload a file, a user can select upload button 404 within the specifications area 402. In some implementations, upon selection, the user can be prompted to upload a file, such as a specification, to the specification component 114.

As shown in FIG. 4A, a successfully uploaded file can be indicated within an area of the interface 142. For example, a successful upload can be indicated by text, such as “success,” “complete,” etc. In some examples, a successful upload can be indicated by an icon (e.g., a checkmark), a color, a highlight, a notification, etc.

In some implementations, a user can desire to review the upload of the file before the file is published. Upon selection of the review button 406, the specification review interface can be displayed where a user can review the specification document text. In some examples, the review interface can be configured to receive user input corresponding to revisions. For example, a user can update a division or section number, a title, etc. In addition, flagged inconsistencies or errors can be highlighted. In some implementations, a user can edit or revise information extracted from the file. As shown in FIG. 4A, a review button 406 can be located within the specifications area 402.

In some implementations, the specification document can be “published” to the project workflow management system 104. A published document, in some implementations, can be integrated into the project workflow management system 104 for access by other components of the project workflow management system 104 (e.g., procedure implementation system 118). In some examples, to publish the specification document, a user can select the publish button 408. As shown in FIG. 4B, the file can be displayed broken down by section. For example, each section (and subsection) of the specification can be listed in columns. In addition, permissions, options for downloading, summaries, source documents, and other information can be displayed.

In some implementations, errors or inconsistencies can be shown to the user. In some implementations, errors can be highlighted to indicate to a user that an error in the file may exist. In some implementations, areas of the index that are missing information may be highlighted to a user. In some implementations, the user may be prompted to correct any errors.

### V. Example Document Feature Extraction Screenshot Walkthrough

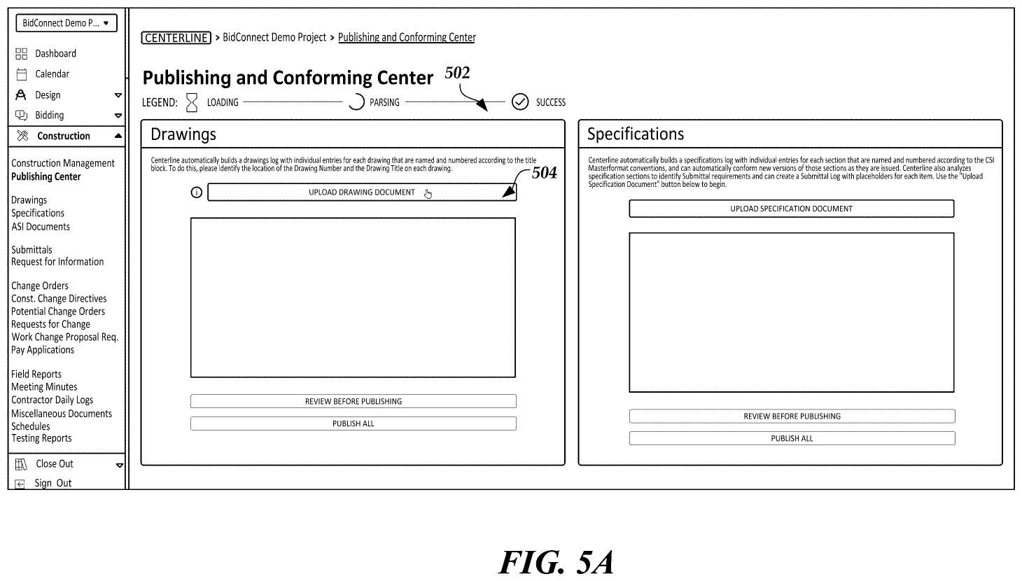

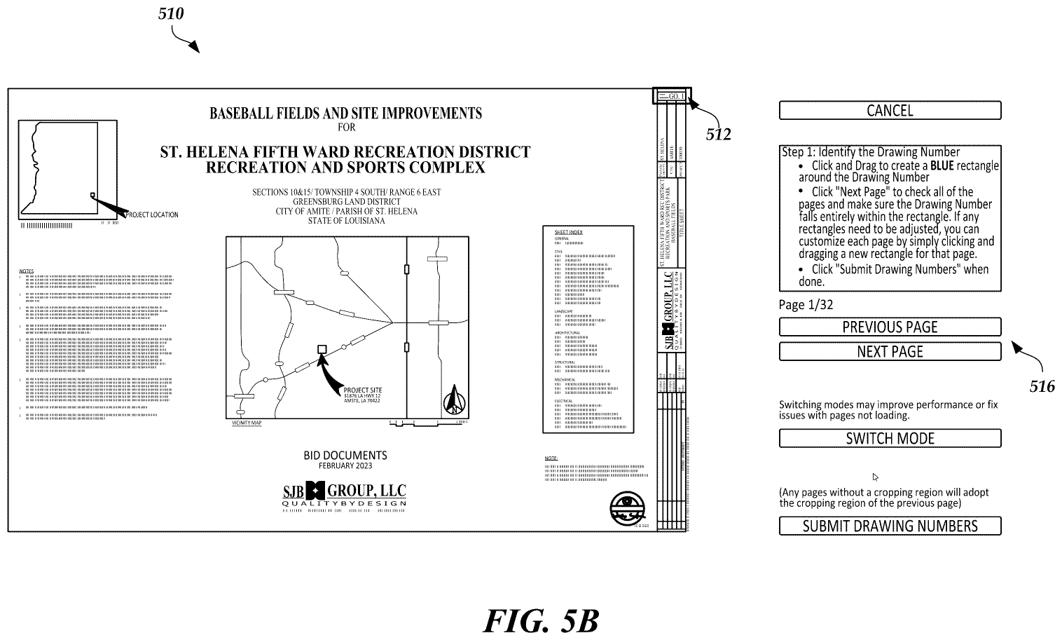

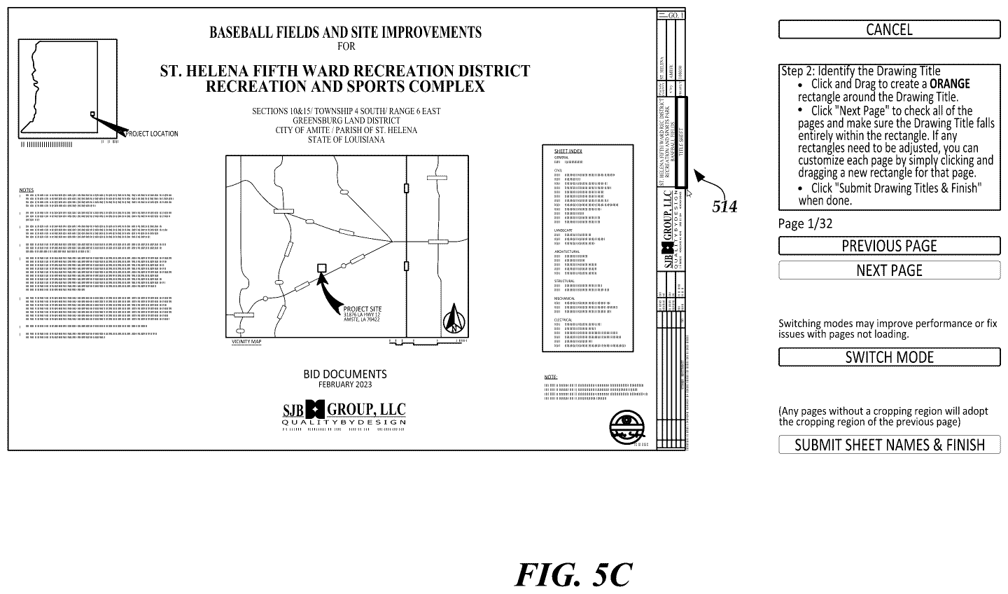

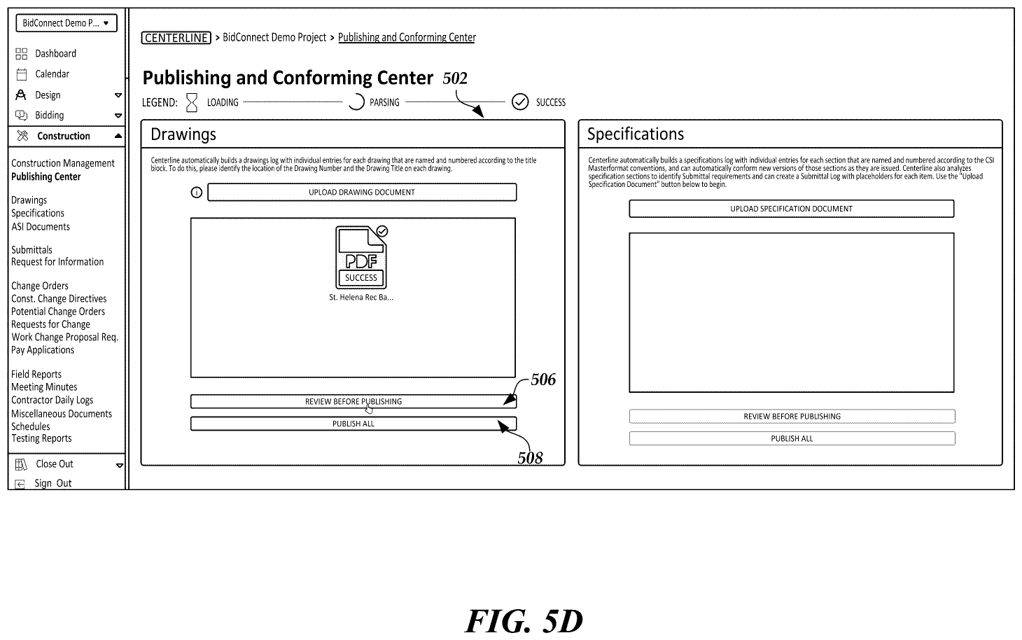

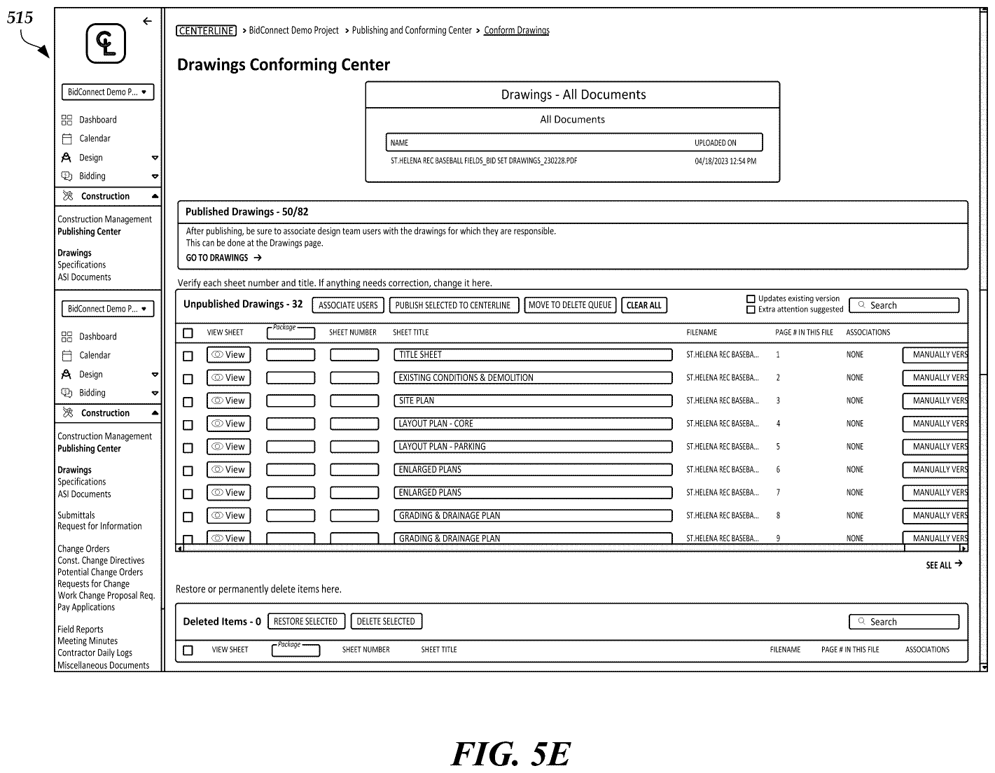

FIGS. 5A-5E illustrate example screenshots of a document feature extraction tool within an example project workflow management system 104.

FIG. 5A illustrates an example interface through which a user can interact with the workflow generation system 112, specifically the drawings component 116. FIG. 5A can be similar to the interface shown in FIG. 4A. As shown in FIG. 5A, a user can interact with various user interface components within the user interface 142 to access the drawings component within a drawings area 502.

In some implementations, to upload a file, a user selects upload button 504 within the drawings area 502. In some implementations, upon selection, the user can be prompted to upload a file, such as a set of drawings. In some implementations, the set of drawings is uploaded to the drawings component 116.

FIGS. 5B and 5C illustrate example interfaces through which a user can interact with the drawings component 116 to provide user input relating to a feature of the file. In some examples, upon upload of a file, the drawings component 116 can display a markup interface 510. In some examples, the markup interface 510 can receive user input related to one or more features of the file. For example, the drawings component 116 can receive a markup or other indicator on the file corresponding to a certain feature on the file, such as a page number, a drawing title, a title, etc. In some implementations, receiving the user input indicating the feature includes segmenting an area of the feature. In this example, the area includes a box, square, rectangle, circle, oval, triangle, or the like. In some examples, a user can indicate the feature on the file by drawing a box around the feature, highlighting the feature, clicking the feature, or otherwise selecting an area corresponding to the feature. For example, the user can draw a box around a page number of the file. In some implementations, more than one feature can be indicated on the file. To differentiate between the different features, different colors, highlights, textures, or other markup features can be used. As shown in FIG. 5B, a first markup indicator 512 is shown over the drawing number. Also shown in FIG. 5C is a second markup indicator 514 over the drawing title. The first and second markup indicators can be different colors, highlights, textures, etc. to indicate a difference in the type of feature.

In some implementations, a user can be prompted to provide one or more inputs to each page of a set of drawings, etc. As shown by navigation buttons 516 within the markup interface 510, the user can navigate through each page of a set of drawings or other types of files. In some implementations, once a user has identified the feature(s) within the file, the user can upload the file to the project workflow management system 104.

As shown in FIG. 5D, a successfully uploaded file can be indicated within an area of the interface 142, such as within the drawings area 502. For example, a successful upload can be indicated by text, such as “success,” “complete,” etc. In some examples, a successful upload can be indicated by an icon (e.g., a checkmark), a color, a highlight, a notification, etc.

In some implementations, a user can desire to review the upload of the file before the file is published. As shown in FIG. 5D, a review button 506 can be located within the drawings area 502. Upon selection of the review button 406, a drawings review interface 515 can be displayed. As shown in FIG. 5E, the drawings review interface 515 can be configured to receive user input corresponding to revisions. For example, a user can update a sheet title or page number, etc.

In some implementations, the file can be “published” to the project workflow management system 104. A published document, in some implementations, can be integrated into the project workflow management system 104 for access by other components of the project workflow management system 104 (e.g., procedure implementation system 118). In some examples, to publish the file, a user can select the publish button 408.

In some implementations, errors or inconsistencies can be shown to the user. In some implementations, errors can be highlighted to indicate to a user that an error in the file may exist. In some implementations, areas of the index that are missing information may be highlighted to a user. In some implementations, the user may be prompted to correct any errors.

### VI. Example Computing System

All of the methods and tasks described herein can be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.) The various functions disclosed herein can be embodied in such program instructions or can be implemented in application-specific circuitry (e.g., ASICs or FPGAs) of the computer system. Where the computer system includes multiple computing devices, these devices may, but need not, be co-located. The results of the disclosed methods and tasks can be persistently stored by transforming physical storage devices, such as solid-state memory chips or magnetic disks, into a different state. In some implementations, the computer system can be a cloud-based computing system whose processing resources are shared by multiple distinct business entities or other users.

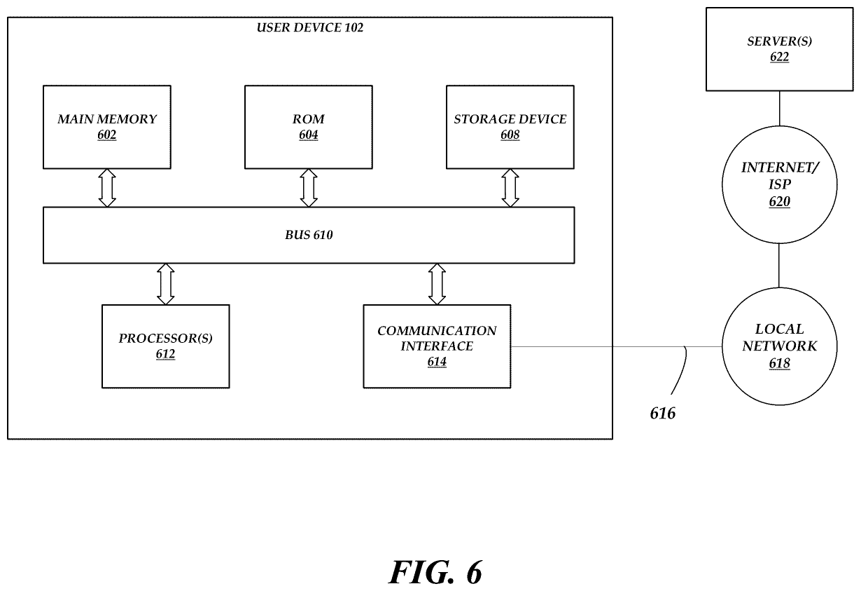

For example, FIG. 6 is a block diagram that illustrates the user device 102 upon which various implementations can be implemented. The user device 102 includes a bus 610 or other communication mechanism for communicating information, and a hardware processor, or multiple processors, 612 coupled with bus 610 for processing information. Hardware processor(s) 612 can be, for example, one or more general purpose microprocessors.

The user device 102 also includes a main memory 602, such as a random-access memory (RAM), cache and/or other dynamic storage devices, coupled to bus 610 for storing information and instructions to be executed by processor 612. Main memory 602 also can be used for storing temporary variables or other intermediary information during execution of instructions to be executed by processor 612. Such instructions, when stored in storage media accessible to processor 612, render user device 102 into a special-purpose machine that is customized to perform the operations specified in the instructions.

The user device 102 further includes a read only memory (ROM) 604 or other static storage device coupled to bus 610 for storing static information and instructions for processor 612. A storage device 608, such as a magnetic disk, optical disk, or USB thumb drive (Flash drive), etc., is provided and coupled to bus 610 for storing information and instructions.

Various forms of computer readable storage media can be involved in carrying one or more sequences of one or more computer readable program instructions to processor 612 for execution. For example, the instructions can initially be carried on a magnetic disk or solid-state drive of a remote computer. The remote computer can load the instructions into its dynamic memory and send the instructions over a telephone line using a modem. A modem local to user device can receive the data on the telephone line and use an infrared transmitter to convert the data to an infra-red signal. An infra-red detector can receive the data carried in the infra-red signal and appropriate circuitry can place the data on bus 610. Bus 610 carries the data to main memory 602, from which processor 612 retrieves and executes the instructions. The instructions received by main memory 606 can optionally be stored on storage device 708 either before or after execution by processor 612.

User device 102 also includes a communication interface 614 coupled to bus 610. Communication interface 614 provides a two-way data communication coupling to a network link 616 that is connected to a local network 618. For example, communication interface 614 can be an integrated services digital network (ISDN) card, cable modem, satellite modem, or a modem to provide a data communication connection to a corresponding type of telephone line. As another example, communication interface 614 can be a local area network (LAN) card to provide a data communication connection to a compatible LAN (or WAN component to communicated with a WAN). Wireless links can also be implemented. In any such implementation, communication interface 614 sends and receives electrical, electromagnetic or optical signals that carry digital data streams representing various types of information.

Network link 616 typically provides data communication through one or more networks to other data devices. For example, network link 616 can provide a connection through local network 618 to data equipment operated by an Internet Service Provider (ISP) 620. ISP 620 in turn provides data communication services through the worldwide packet data communication network now commonly referred to as the “Internet” 620. Local network 618 and Internet 620 both use electrical, electromagnetic or optical signals that carry digital data streams. The signals through the various networks and the signals on network link 616 and through communication interface 614, which carry the digital data to and from user device 102, are example forms of transmission media.

User device 102 can send messages and receive data, including program code, through the network(s), network link 616 and communication interface 614. In the Internet example, a server 622 might transmit a requested code for an application program through Internet/ISP 620, local network 618 and communication interface 614.

### VII. Additional Implementation Details, Terminology, and Clauses

A number of different types of AI/ML algorithms and AI/ML models may be used by the project workflow management system. Further, these AI/ML models may be developed and/or trained using various methods. For example, certain implementations herein may use a logistical regression model, decision trees, random forests, convolutional neural networks, deep networks, or others. However, other models are possible, such as a linear regression model, a discrete choice model, or a generalized linear model. The machine learning aspects can be configured to adaptively develop and update the models over time based on new input. For example, the models can be trained, retrained, or otherwise updated on a periodic basis as new received data is available to help keep the predictions in the model more accurate as the data is collected over time. Also, for example, the models can be trained, retrained, or otherwise updated based on configurations received from a user, admin, or other devices. Some non-limiting examples of machine learning algorithms that can be used to train, retrain, or otherwise update the models can include supervised and non-supervised machine learning algorithms, including regression algorithms (such as, for example, Ordinary Least Squares Regression), instance-based algorithms (such as, for example, Learning Vector Quantization), decision tree algorithms (such as, for example, classification and regression trees), Bayesian algorithms (such as, for example, Naive Bayes), clustering algorithms (such as, for example, k-means clustering), association rule learning algorithms (such as, for example, Apriori algorithms), artificial neural network algorithms (such as, for example, Perceptron), deep learning algorithms (such as, for example, Deep Boltzmann Machine), dimensionality reduction algorithms (such as, for example, Principal Component Analysis), ensemble algorithms (such as, for example, Stacked Generalization), support-vector machines, federated learning, and/or other machine learning algorithm. These machine learning algorithms may include any type of machine learning algorithm including hierarchical clustering algorithms and cluster analysis algorithms, such as a k-means algorithm. In some cases, the performing of the machine learning algorithms may include the use of an artificial neural network. By using machine-learning techniques, large amounts (such as terabytes or petabytes) of received data may be analyzed to generate or implement models with minimal, or with no, manual analysis or review by one or more people.

It is to be understood that not necessarily all objects or advantages may be achieved in accordance with any particular implementations described herein. Thus, for example, those skilled in the art will recognize that certain implementations may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the implementation, certain acts, events, or functions of any of the algorithms described herein can be performed in a different sequence, can be added, merged, or left out altogether (e.g., not all described acts or events are necessary for the practice of the algorithms). Moreover, in certain implementations, acts or -events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

As described above, in various implementations certain functionality can be accessible by a user through a web-based viewer (such as a web browser), or other suitable software program. In such implementations, the user interface can be generated by a server computing system and transmitted to a web browser of the user (e.g., running on the user's computing system). Alternatively, data (e.g., user interface data) necessary for generating the user interface can be provided by the server computing system to the browser, where the user interface can be generated (e.g., the user interface data can be executed by a browser accessing a web service and can be configured to render the user interfaces based on the user interface data). The user can then interact with the user interface through the web-browser. User interfaces of certain implementations can be accessible through one or more dedicated software applications. In certain implementations, one or more of the computing devices and/or systems of the disclosure can include mobile computing devices, and user interfaces can be accessible through such mobile computing devices (for example, smartphones and/or tablets).

The various illustrative logical blocks and modules described in connection with the implementations disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another implementation, a processor includes an FPGA or other programmable device that performs logic operations without processing computer-executable instructions. A processor can also be implemented as a combination of electronic devices, e.g., a combination of a DSP and a microprocessor, a plurality of microprocessors, one or more microprocessors in conjunction with a DSP core, or any other such configuration. Although described herein primarily with respect to digital technology, a processor can also include primarily analog components. A computing environment can include any type of computer system, including, but not limited to, a computer system based on a microprocessor, a mainframe computer, a digital signal processor, a portable electronic device, a device controller, or a computational engine within an appliance, to name a few.

Many variations and modifications can be made to the above-described implementations or implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language such as, among others, “can,” “could,” “might,” or “may,” unless specifically stated otherwise, are otherwise understood within the context as used in general to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like can be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present. Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Any process descriptions, elements or blocks in the flow diagrams described herein and/or depicted in the attached FIGs. should be understood as potentially representing modules, segments, or portions of code which include one or more executable instructions for implementing specific logical functions or elements in the process. Alternate implementations are included within the scope of the implementations described herein in which elements or functions can be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The term “comprising” as used herein should be given an inclusive rather than exclusive interpretation. For example, a general-purpose computer comprising one or more processors should not be interpreted as excluding other computer components, and can possibly include such components as memory, input/output devices, and/or network interfaces, among others.

While the above detailed description has shown, described, and pointed out novel features as applied to various implementations, it can be understood that various omissions, substitutions, and changes in the form and details of the devices or processes illustrated can be made without departing from the spirit of the disclosure. As can be recognized, certain implementations of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

Examples of the implementations of the present disclosure can be described in view of the following example clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

Clause 1: A method for managing a project workflow, comprising: accessing a file corresponding to a specification; identifying a table of contents in the specification, wherein the table of contents includes a plurality of divisions and a plurality of sections; determining an instruction in the specification, wherein the instruction is identified by the corresponding division and section; generating an index based on the table of contents, wherein the index includes the plurality of divisions and the plurality of sections; and generating a task based on the identified instruction and the corresponding division and section.

Clause 2: The method of clause 1, wherein determining the instruction comprises searching the file based on a keyword; and identifying the instruction within the division and the section of the specification identified by the keyword.

Clause 3: The method of clause 1 or clause 2, wherein the keyword indicates one of a start of a section or an end of a section.

Clause 4: The method of any of clauses 1 to 3, further comprising: displaying the index on a display; receiving a user input corresponding to a revision to the index; and updating the index based on the user input corresponding to the revision.

Clause 5: The method of any of clauses 1 to 4, further comprising: identifying an error in the index, wherein the error includes one of an inconsistency between content of the specification and the table of contents, a typographical error, a missing division or section.

Clause 6: The method of any of clauses 1 to 5, wherein the instruction includes one of a request for an action to be executed by a third party, or a request for information from the third party.

Clause 7: The method of clause 6, wherein generating the task further comprises generating a notification based on the instruction to the third party.

Clause 8: The method of any of clauses 1 to 7, further comprising: tracking progress of the task based on actions of a third party; and updating a status of the task based on the tracked progress.

Clause 9: A method, comprising: accessing a file; displaying the file on a display; receiving a user input indicating a feature on the file; generating an index based on the feature; and generating a task based on the feature.

Clause 10: The method of clause 9, wherein the file includes one of a floorplan, blueprint, layout, or a design.

Clause 11: The method of clause 9 or clause 10, wherein the feature is one of a page number, a drawing number, or a title.

Clause 12: The method of any of clauses 9 to 11, wherein receiving the user input indicating the feature further comprises segmenting an area of the feature, herein the area is one of a square, rectangle, circle, oval, or triangle.

Clause 13: The method of any of clauses 9 to 12, further comprising: displaying the index on the display; receiving a second user input corresponding to a revision to the index; and updating the index based on the user input corresponding to the revision.

Clause 14: The method of any of clauses 9 to 13, wherein generating the task further comprises generating a notification based on the instruction to the third party.

Clause 15: The method of any of clauses 9 to 14, further comprising: tracking progress of the task based on actions of a third party; and updating a status of the task based on the tracked progress.

Clause 16: A method for managing a project workflow, comprising: accessing a file corresponding to a specification; identifying a table of contents in the specification; determining an instruction in the specification related to the project workflow; and generating a task based on the identified instruction.

Clause 17: The method of clause 16, wherein determining the instruction comprises: searching the specification based on a keyword; and identifying the instruction within a division and a section of the specification identified by the keyword.

Clause 18: The method of clause 16 or clause 17, wherein the instruction includes one of a request for an action to be executed by a third party, or a request for information from the third party.

Clause 19: The method of any of clauses 16 to 18, wherein generating the task further comprises generating a notification based on the instruction to the third party.

Clause 20: The method of any of clauses 16 to 19, further comprising: tracking progress of the task based on actions of a third party; and updating a status of the task based on the tracked progress.

What is claimed is:

1. A method for managing a project workflow, comprising:
accessing a file corresponding to a specification;
identifying a table of contents in the specification, wherein the table of contents includes a plurality of divisions and a plurality of sections;
determining an instruction in the specification, wherein the instruction is identified by the corresponding division and section;
generating an index based on the table of contents, wherein the index includes the plurality of divisions and the plurality of sections; and
generating a task based on the identified instruction and the corresponding division and section.

2. The method of claim 1, wherein determining the instruction comprises
searching the file based on a keyword; and
identifying the instruction within the division and the section of the specification identified by the keyword.

3. The method of claim 2, wherein the keyword indicates one of a start of a section or an end of a section.

4. The method of claim 1, further comprising:
displaying the index on a display;
receiving a user input corresponding to a revision to the index; and
updating the index based on the user input corresponding to the revision.

5. The method of claim 1, further comprising: identifying an error in the index, wherein the error includes one of an inconsistency between content of the specification and the table of contents, a typographical error, a missing division or section.

6. The method of claim 1, wherein the instruction includes one of a request for an action to be executed by a third party, or a request for information from the third party.

7. The method of claim 6, wherein generating the task further comprises generating a notification based on the instruction to the third party.

8. The method of claim 1, further comprising:
tracking progress of the task based on actions of a third party; and
updating a status of the task based on the tracked progress.

9. A method, comprising:
accessing a file;
displaying the file on a display;
receiving a user input indicating a feature on the file;
generating an index based on the feature; and
generating a task based on the feature.

10. The method of claim 9, wherein the file includes one of a floorplan, blueprint, layout, or a design.

11. The method of claim 9, wherein the feature is one of a page number, a drawing number, or a title.

12. The method of claim 9, wherein receiving the user input indicating the feature further comprises segmenting an area of the feature, wherein the area is one of a square, rectangle, circle, oval, or triangle.

13. The method of claim 9, further comprising:
displaying the index on the display;
receiving a second user input corresponding to a revision to the index; and
updating the index based on the user input corresponding to the revision.

14. The method of claim 9, further comprising:
tracking progress of the task based on actions of a third party; and
updating a status of the task based on the tracked progress.

15. The method of claim 14, wherein generating the task further comprises generating a notification based on an instruction to the third party.

16. A method for managing a project workflow, comprising:
accessing a file corresponding to a specification;
identifying a table of contents in the specification;
determining an instruction in the specification related to the project workflow; and
generating a task based on the identified instruction.

17. The method of claim 16, wherein determining the instruction comprises:
searching the specification based on a keyword; and
identifying the instruction within a division and a section of the specification identified by the keyword.

18. The method of claim 16, wherein the instruction includes one of a request for an action to be executed by a third party, or a request for information from the third party.

19. The method of claim 18, wherein generating the task further comprises generating a notification based on the instruction to the third party.

20. The method of claim 16, further comprising:
tracking progress of the task based on actions of a third party; and
updating a status of the task based on the tracked progress.
